(19) United States
(12) Patent Application Publication
(10) Pub. No.: US 2018/0276891 A1
(43) Pub. Date: Sep. 27, 2018

(54) SYSTEM AND METHOD FOR PROVIDING AN IN-CONTEXT NOTIFICATION OF A REAL-WORLD EVENT WITHIN A VIRTUAL REALITY EXPERIENCE

(71) Applicant: PCMS Holdings, Inc., Wilmington, DE (US)

(72) Inventor: Michael L. Craner, Chester Springs, PA (US)

(21) Appl. No.: 15/928,669

(22) Filed: Mar. 22, 2018

Related U.S. Application Data
(60) Provisional application No. 62/476,426, filed on Mar. 24, 2017.

(51) Int. Cl. G06T 19/00; G06T 19/20; G08B 21/02

(52) U.S. Cl. CPC G06T 19/003; H04L 51/24; G08B 21/02; G06T 19/20

(57) ABSTRACT

An in-context notification of a real-world event within a virtual reality (VR) experience includes a process for generating a VR scene using a VR wearable display device in a real-world VR viewing location. The process includes identifying a real-world event in the real-world VR viewing location. The process also includes determining a context of the VR scene and applying a modification to the VR scene in response to the identified real-world event, wherein the modification is associated with the context of the VR scene.

### CROSS-REFERENCE TO RELATED APPLICATIONS

The present application is a non-provisional filing of, and claims benefit under 35 U.S.C. § 119(e) from, U.S. Provisional Patent Application Ser. No. 62/476,426, filed Mar. 24, 2017, entitled “SYSTEM AND METHOD FOR PROVIDING AN IN-CONTEXT NOTIFICATION OF A REAL-WORLD EVENT WITHIN A VIRTUAL REALITY EXPERIENCE”, which is incorporated herein by reference in its entirety.

### BACKGROUND

In today's internet age, there is a trend towards consuming richer and more immersive digital content. How we access this content is changing at a rapid pace. Streaming digital data has become a standard means by which a user receives digital content. Digital media with greater levels of realism are encoded using high-resolution formats which demand large file sizes. Transporting this information requires a proportionally large allocation of communication resources. Visually rich virtual reality (VR) content and augmented reality (AR) content both require novel display devices for proper rendering. In the case of VR content and certain immersive AR experiences, the associated display devices are bulky and tethered to large processing units and also prevent a user from being aware of various hazards and events in the real-world environment. As processing power continues to evolve and these devices become untethered and users become more mobile, while still being isolated from the real-world physical reality around them, these systems become more dangerous to use independently. For at least these reasons, current VR and immersive AR content consumption often relies on a human supervisor being present for safety purposes. However, this is a prohibitive requirement.

VR content may be obtained by a VR device, such as a VR headset. In some instances, VR content is in a local storage of the device and is selected manually by a user of the VR device. Modern VR and AR devices are not very aware of their surroundings. However, they are good at accurately and precisely tracking the position and orientation on the device within the real-world environment. Also, many modern devices can create a digital 3D reconstruction of a present real-world viewing environment and various analyses may be performed on this data to facilitate enhanced functionalities. Due to the advanced sensing abilities of VR and AR devices, enhanced systems and processes for providing various types of contextually relevant content may be provided. Furthermore, novel and exciting media consumption experiences may be facilitated.

### SUMMARY

This disclosure describes systems and methods for providing an in-context notification of a real-world event within a VR experience. In some embodiments, a process includes generating a virtual reality (VR) scene using a VR wearable display device in a real-world VR viewing location. The process may also include identifying a real-world event in the real-world VR viewing location. The process may also include determining a context of the VR scene. The process may further include applying a modification to the VR scene in response to the identified real-world event, wherein the modification is associated with the context of the VR scene.

In some embodiments, determining the context of the VR scene includes receiving the context from a current VR program, and applying the modification to the VR scene in response to the identified real-world event includes selecting a context-associated VR object from a database of VR objects.

In some embodiments, identifying the real-world event includes using at least one selected from the group consisting of sonar, lidar, radar, stereo vision, motion tracking, artificial intelligence, and object recognition.

In some embodiments, identifying the real-world event includes identifying an incoming digital communication. In at least one such embodiment, applying the modification to the VR scene in response to the identified real-world event includes generating a context-associated object representing a characteristic of the incoming digital communication.

In some embodiments, identifying the real-world event includes identifying a biometric parameter, wherein the biometric parameter is indicative of a physiological state of a VR user of the VR wearable display device and of the physiological state surpassing a threshold level for the physiological state. In at least one such embodiment, applying the modification to the VR scene in response to the identified real-world event includes modulating the intensity of a current VR program.

In some embodiments, identifying the real-world event in the real-world VR viewing location includes detecting a potential collision between a VR user of the VR wearable display device and an obstacle within the real-world VR viewing location. In some embodiments, the process further includes determining a relative motion of the VR user with respect to the obstacle and applying the modification to the VR scene in response to the identified real-world event includes generating a context-associated VR object to affect the relative motion of the VR user with respect to the obstacle to avoid the potential collision. In some embodiments, the obstacle is a stationary object. In some embodiments, the obstacle is a mobile object.

In some embodiments, the obstacle is a second VR user of a second VR wearable display device. In some such embodiments, the process further includes accessing a rule from a set of common rules, wherein the set of common rules is shared between the VR wearable display device and the second VR wearable device such that the VR wearable display device is configured to operate in accordance with the set of common rules and also includes providing guidance to the VR user with respect to avoiding potential collisions in accordance with the rule.

In some embodiments, generating the context-associated VR object includes communicating with the second VR wearable display device to exchange cooperation information and generating the context-associated VR object based at least in part on the cooperation information. In some such embodiments, the cooperation information includes anticipated changes in a direction and a location of at least one of the VR user or the second VR user.

In some embodiments, the process includes determining information regarding a user response of the VR user to the context-associated VR object. The process also includes sending the information regarding the user response to a learning engine, wherein the learning engine is configured to modify a timing for generating a subsequent context-associated VR object based at least in part on the information regarding the user response.

In some embodiments, generating the context-associated VR object includes generating the context-associated VR object based at least in part on a potential severity of the potential collision. In at least one such embodiment, the potential severity is based on a relative velocity between the VR user and the obstacle and a distance between the VR user and the obstacle.

An example system in accordance with some embodiments includes a processor and non-transitory memory. The non-transitory memory may contain instructions executable by the processor for causing the system to carry out at least the processes described in the preceding paragraphs. In some embodiments, the system includes the VR wearable display device, wherein the VR wearable display device includes the processor and the non-transitory memory.

In some embodiments, another process includes rendering initial virtual reality (VR) views to a VR user using a VR wearable display device in a real-world VR viewing location. The process may also include detecting a real-world obstacle in the real-world VR viewing location. In some embodiments, the real-world obstacle may be a mobile real-world obstacle. The process may also include detecting a potential collision between the VR user on a current trajectory and the mobile real-world obstacle on a second trajectory, the current trajectory intersecting with the second trajectory. The process may also include, in response to detecting the potential collision, rendering, at a display of the VR wearable display device, a context-associated VR object in a VR view, wherein the context-associated VR object is configured to divert the VR user from the current trajectory of the VR user and to avoid the potential collision.

In some embodiments, the context-associated VR object is rendered at a position corresponding to a predicted position of the mobile real-world obstacle at a location of the potential collision.

In some embodiments, the context-associated VR object includes a deterrent configured to the divert the VR user from the potential collision by warning the VR user of the potential collision.

In some embodiments, the context-associated VR object is rendered at a position other than a position of the mobile real-world obstacle.

In some embodiments, the context-associated VR object includes an incentive configured to divert the VR user toward the incentive and away from the potential collision.

In some embodiments, detecting the potential collision includes using at least one of the group consisting of sonar, lidar, radar, stereo vision, motion tracking, artificial intelligence (AI), and object recognition.

In some embodiments, rendering the context-associated VR object includes generating a deterrent to affect the current trajectory of the VR user to avoid the potential collision based at least on a severity of the potential collision. In some such embodiments, the process also includes providing the context-associated VR object to a remote database as an accessible service to other VR applications. In certain embodiments, the process also includes tracking response information indicative of a user response of the VR user after rendering the context-associated VR object, and determining subsequent context-associated VR objects to be presented to the VR user based at least in part on the response information.

In some embodiments, the mobile real-world obstacle is a second VR user of a second VR wearable display device. In at last one such embodiments, detecting the potential collision further includes communicating with the second VR wearable display device to exchange cooperation information to avoid the potential collision.

In some embodiments, communicating with the second VR wearable display device includes communicating according to a standardized signaling protocol compatible with the VR wearable display device and the second VR wearable display device.

In some embodiments, the VR wearable display device and the second VR wearable display device establish a bidirectional communication channel to select a collision avoidance master and a collision avoidance slave, wherein the collision avoidance master determines the cooperation information and then communicates it to the collision avoidance slave.

In some embodiments, the VR wearable display device and the second VR wearable display device establish a bidirectional communication channel to select a collision avoidance master and a collision avoidance slave, wherein the collision avoidance master determines the cooperation information and then communicates it to the collision avoidance slave.

In some embodiments, the cooperation information includes a collision avoidance tactic. In at least one such embodiment, the VR wearable display device and the second VR wearable display device establish a bidirectional communication channel to select a collision avoidance master and a collision avoidance slave, wherein the collision avoidance master determines the collision avoidance tactic and then communicates it to the collision avoidance slave. In a further embodiment, the collision avoidance master also determines a master collision avoidance tactic and communicates it to the collision avoidance slave.

In some embodiments, the VR user and the second VR user share substantially the same real-world VR viewing location, and a first VR representation of the VR user and a second VR representation of the second VR user are used as deterrents.

An example system in accordance with some embodiments includes a communication interface, a processor, and data storage containing instructions executable by the processor for causing the system to carry out at least the process described in the preceding paragraph. In at least one such embodiment, the system includes the VR wearable display device, wherein the VR wearable display device includes the processor and the memory.

An example system in accordance with some embodiments includes a processor and memory. The memory may contain instructions executable by the processor for causing the system to carry out at least the processes described in the preceding paragraphs. In some embodiments, the system includes the VR wearable display device, wherein the VR wearable display device includes the processor and the memory.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 10 is a system diagram illustrating an example radio access network (RAN) and an example core network (CN) that may be used within the communications system illustrated in FIG. 1A according to an embodiment.

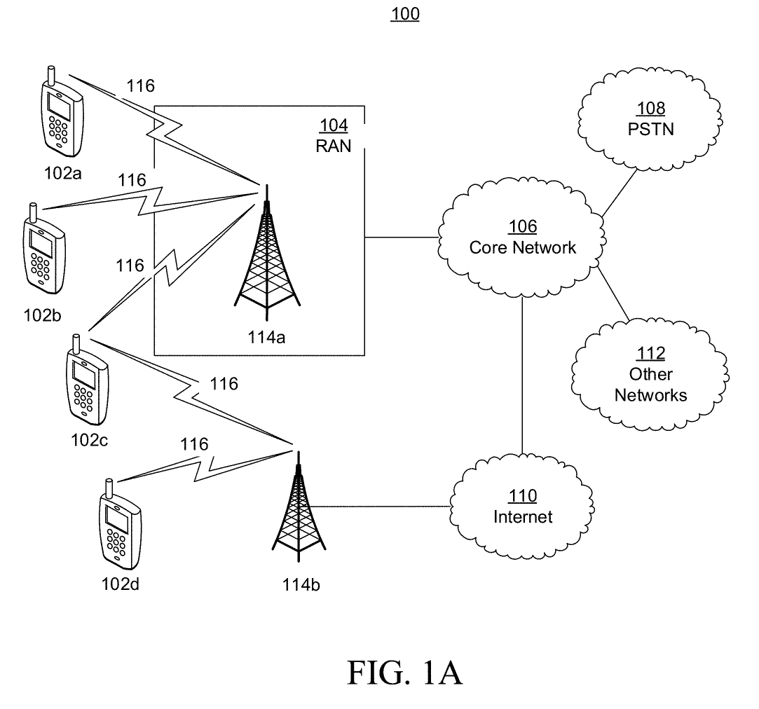

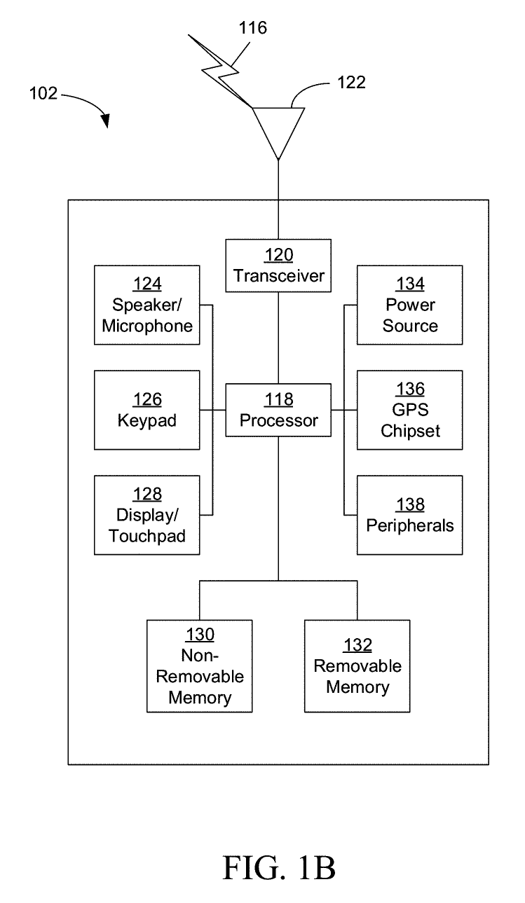

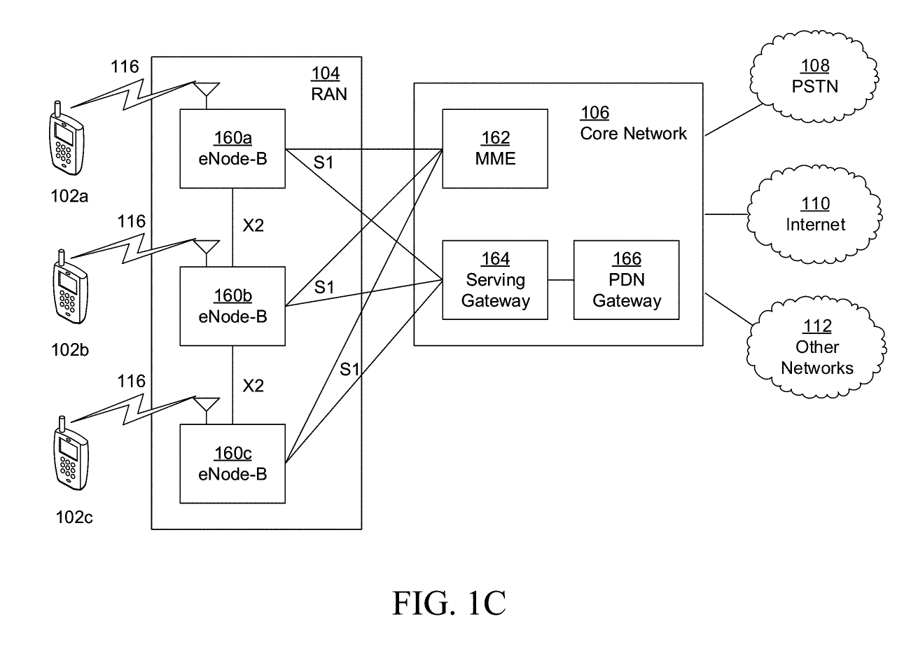

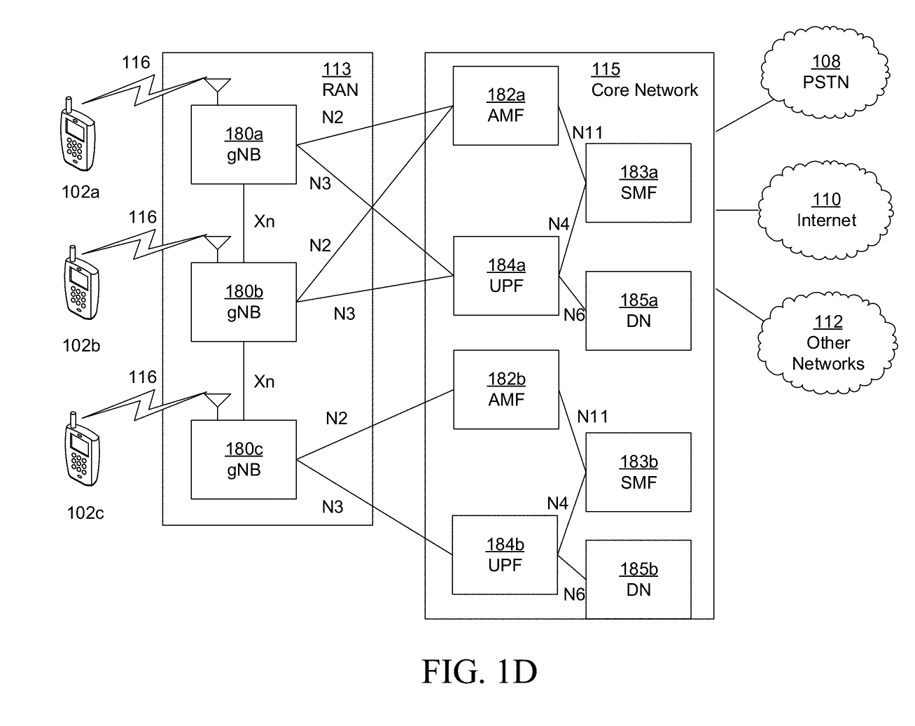

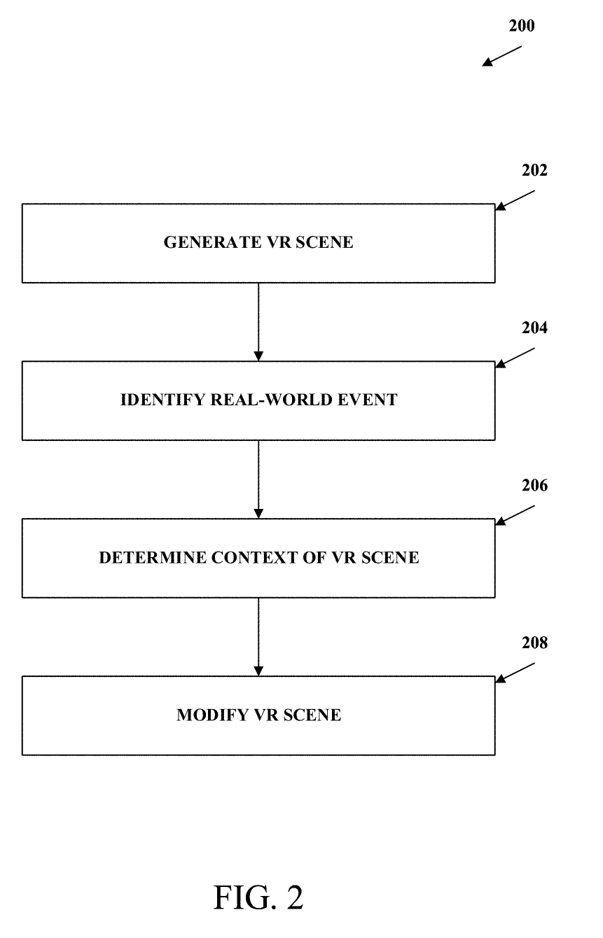

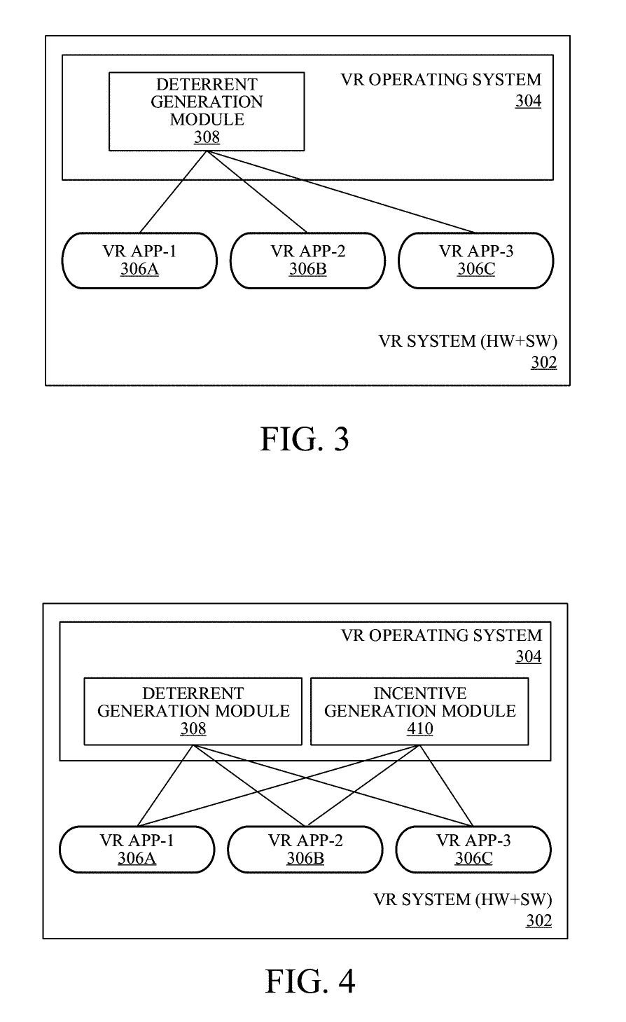

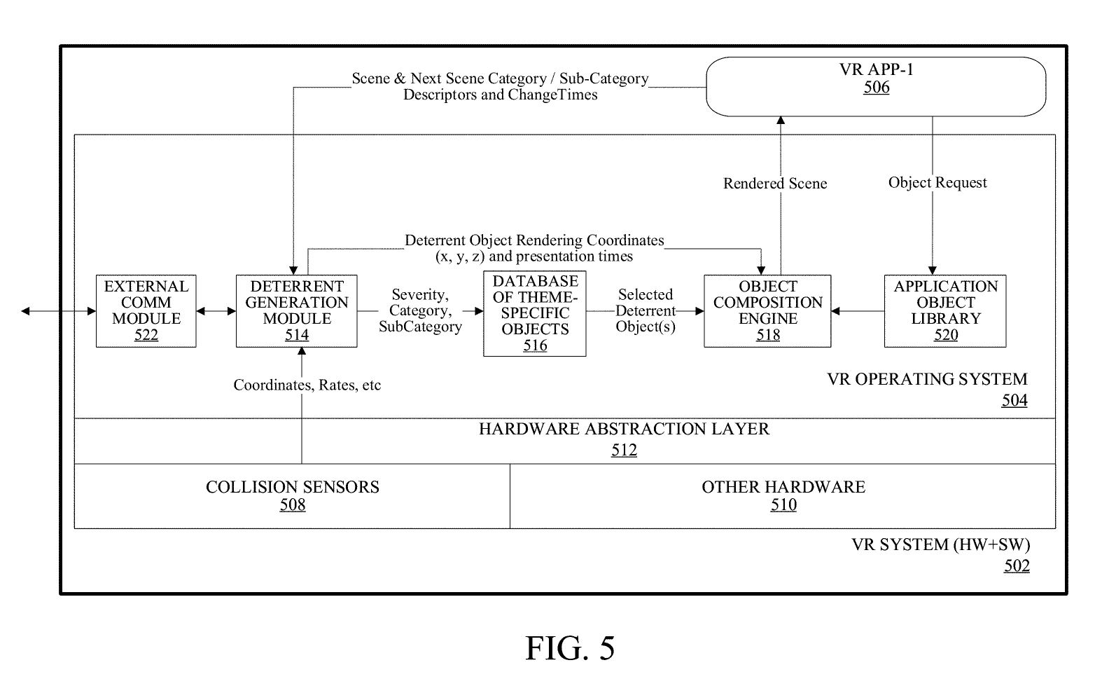

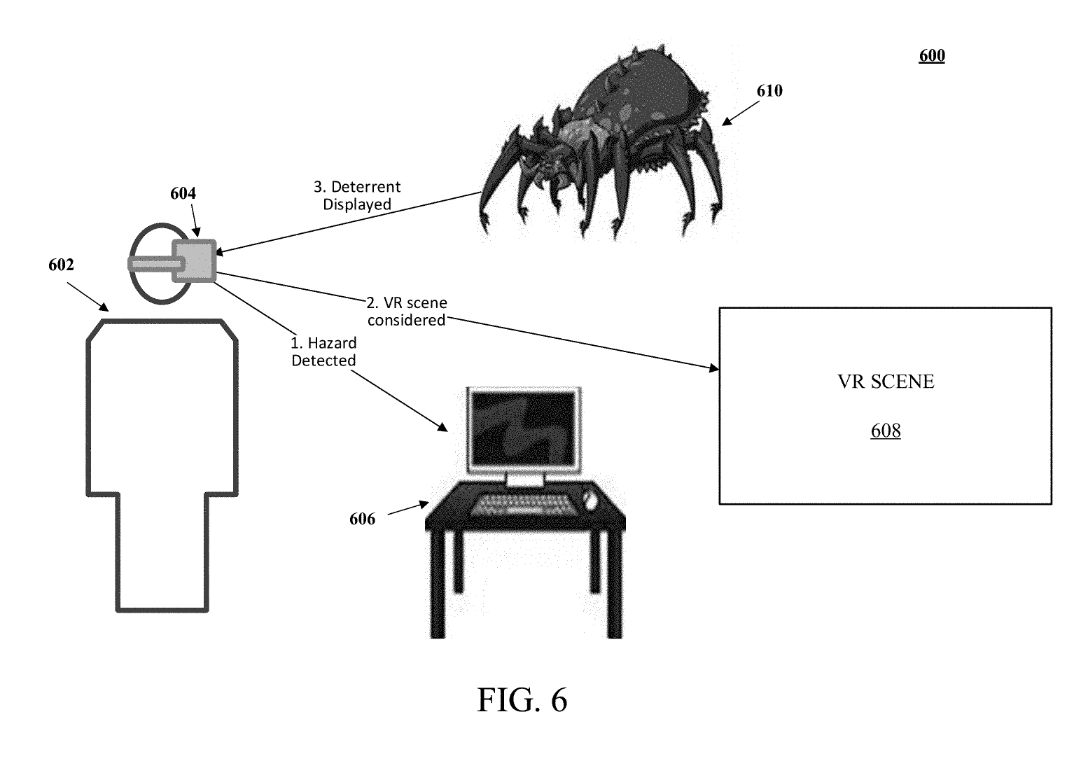

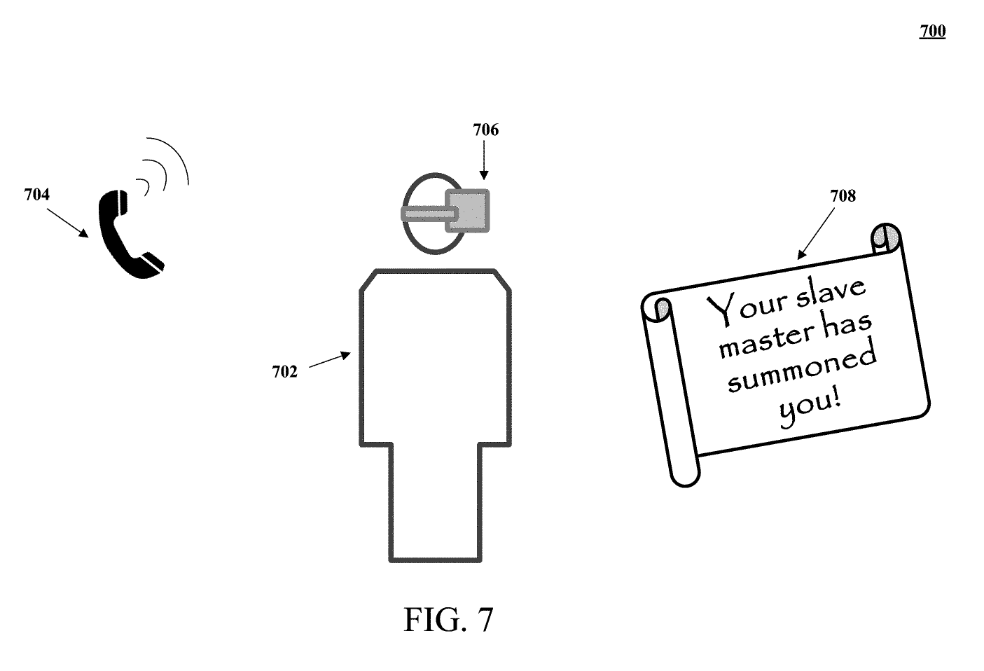

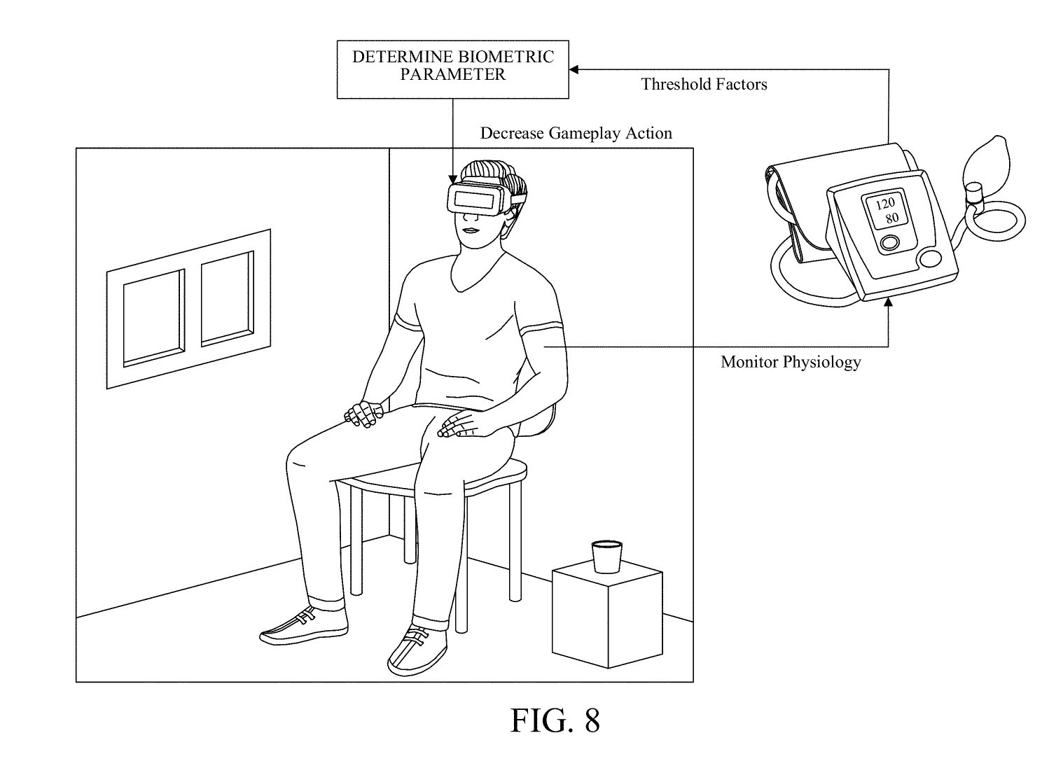

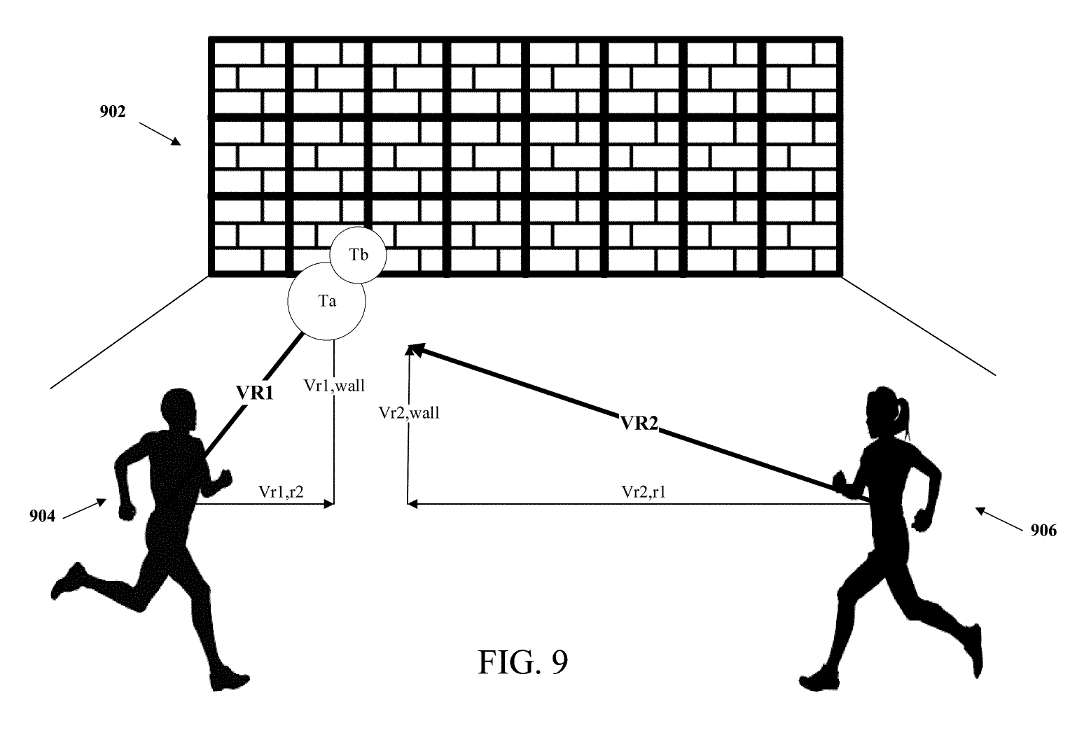

FIG. 1D is a system diagram illustrating a further example RAN and a further example CN that may be used within the communications system illustrated in FIG. 1A according to an embodiment.

FIG. 2 depicts a flow chart of an example method, in accordance with at least one embodiment.

FIG. 3 depicts a first example VR system, in accordance with at least one embodiment.

FIG. 4 depicts the example VR system of FIG. 3 further comprising an incentive generation module, in accordance with at least one embodiment.

FIG. 5 depicts a fourth example VR system, in accordance with at least one embodiment.

FIG. 6 depicts a real-world example scenario including in-context obstacle avoidance, in accordance with at least one embodiment.

FIG. 7 depicts a real-world example scenario including in-context communication alerts, in accordance with at least one embodiment.

FIG. 8 depicts a real-world example scenario including physiological monitoring, in accordance with at least one embodiment.

FIG. 9 depicts two VR users running towards a wall, in accordance with at least one embodiment.

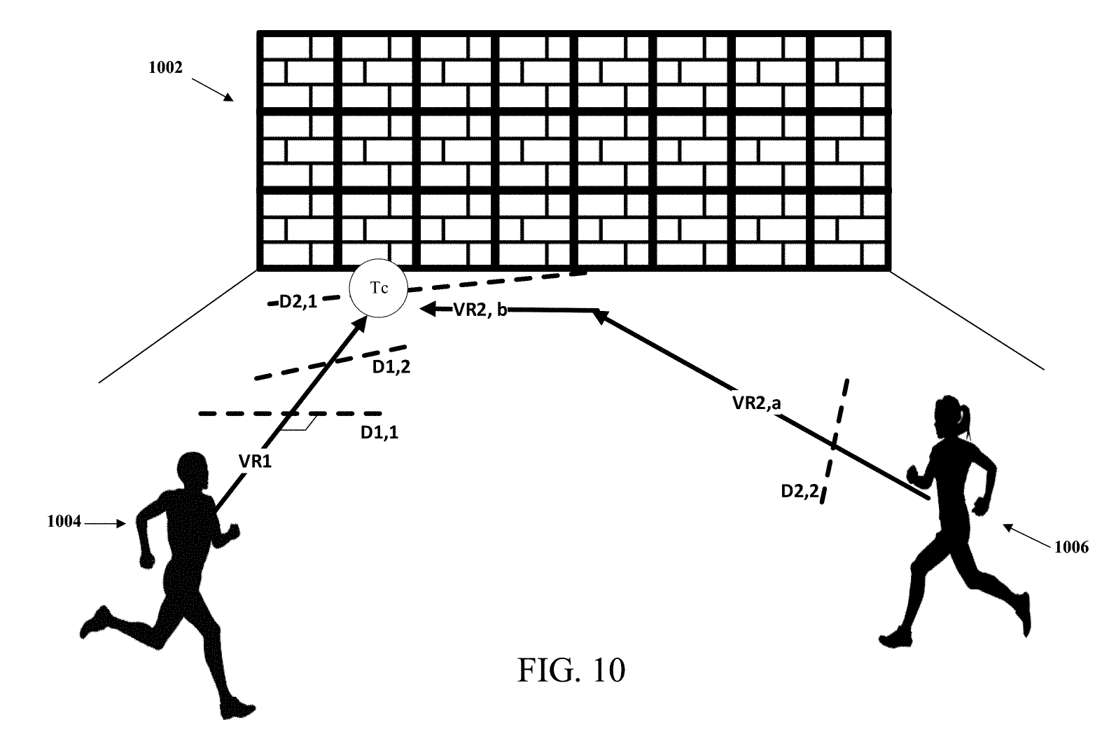

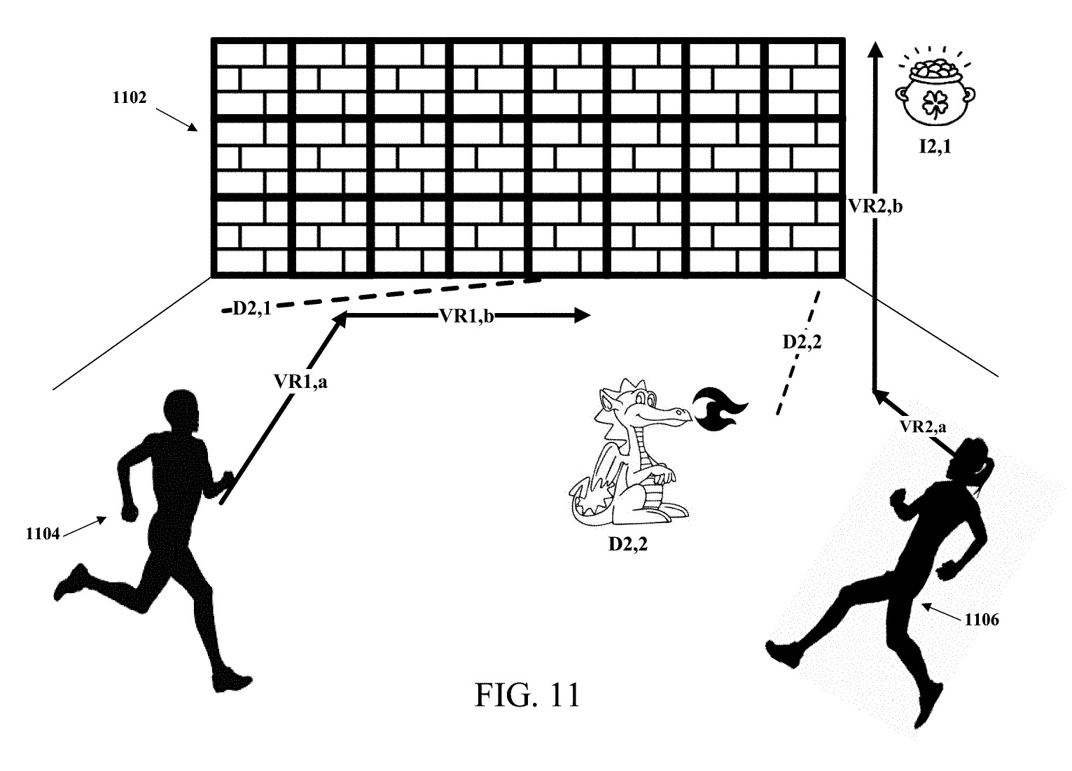

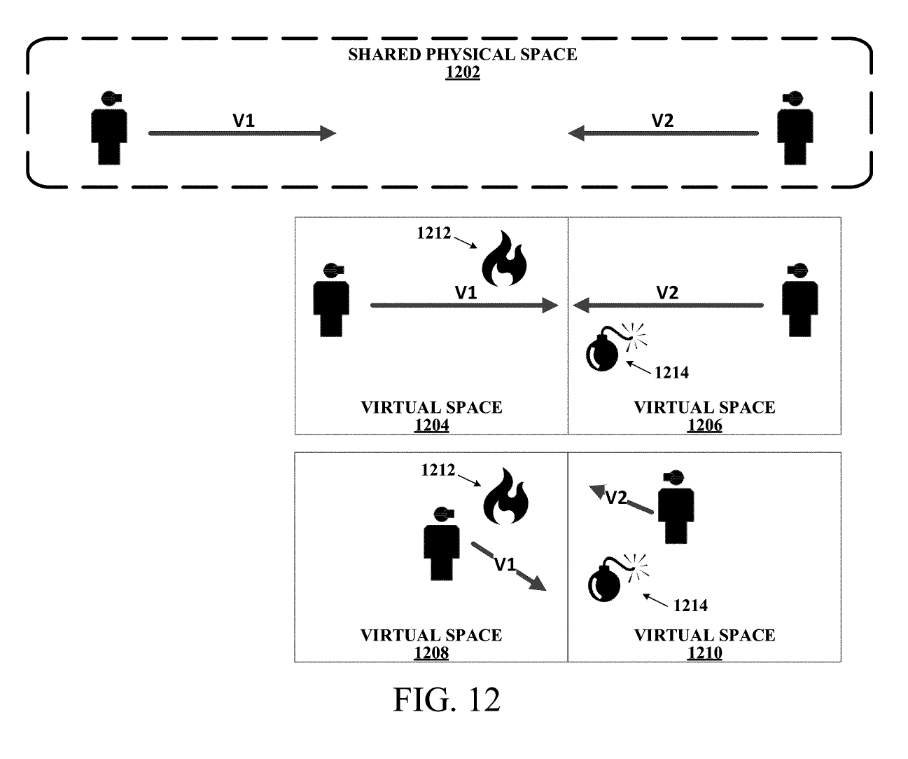

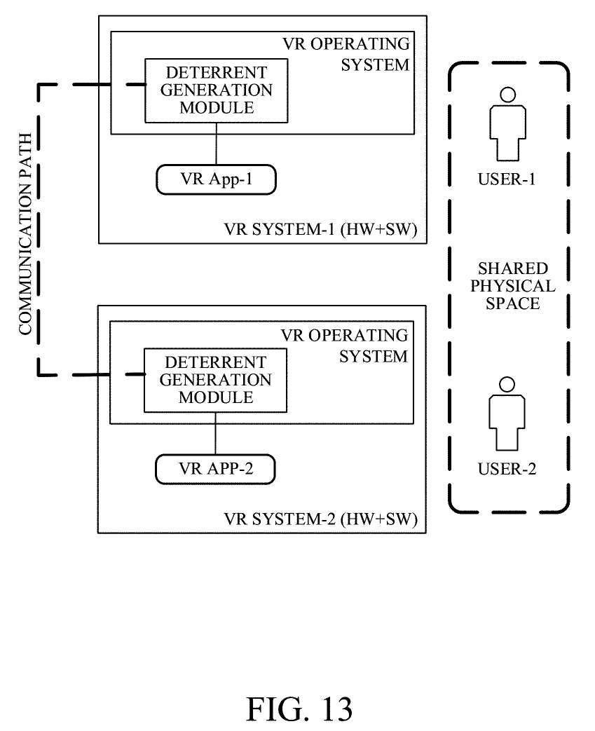

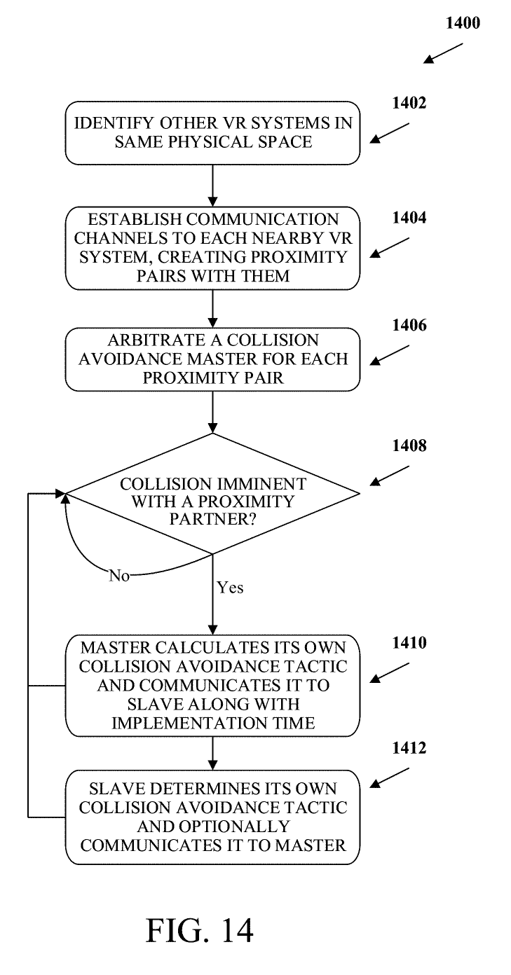

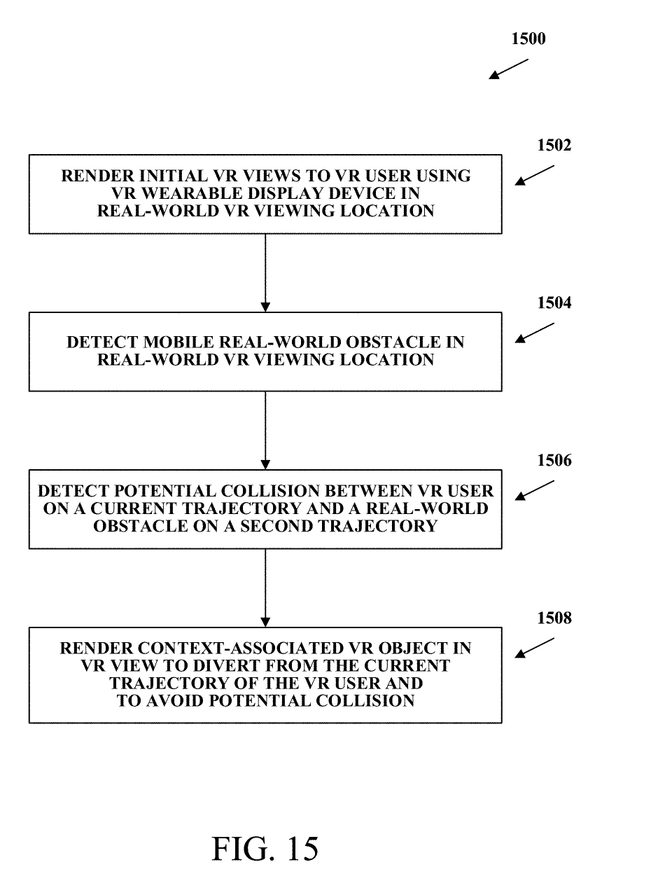

FIG. 10 illustrates 2nd and 3rd degree motion prediction considerations, in accordance with at least one embodiment.

FIG. 11 depicts an example use of incentives as opposed to deterrents, in accordance with at least one embodiment.

FIG. 12 highlights an example independent collision avoidance paradigm, in accordance with at least on embodiment.

FIG. 13 depicts two VR users and corresponding VR systems in communication with each other, in accordance with at least on embodiment.

FIG. 14 depicts a flow chart of a multi-device collision avoidance method, in accordance with at least one embodiment.

FIG. 15 depicts a flow chart for an example method in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Before proceeding with this detailed description, it is noted that the entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—can only properly be read as being constructively preceded by a clause such as “In at least one embodiment, . . . .” And it is for reasons akin to brevity and clarity of presentation that this implied leading clause is not repeated ad nauseum in this detailed description.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

### Example Networks for Implementation of the Embodiments.

FIG. 1A is a diagram illustrating an example communications system 100 in which one or more disclosed embodiments may be implemented. The communications system 100 may be a multiple access system that provides content, such as voice, data (e.g., virtual reality modeling language (VRML)), video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite as well as packet switched communication protocols such as voice over IP (VoIP). The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138 (e.g., video cameras), among others. It will be appreciated that the WTRU 102 may include any sub-combination of the foregoing elements while remaining consistent with an embodiment.

The processor 118 may be a general purpose processor, a special purpose processor (such as, for example a graphics processing unit with virtual reality and deep learning support, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, deep learning, virtual reality rendering, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, a deep learning AI accelerator, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Description of the Embodiments

Exemplary systems and processes disclosed herein determine whether a virtual reality (VR) user is facing an imminent real-world hazard or obstacle while in a VR session and then render and display an appropriate-priority in-context virtual visual and/or audible deterrent (or incentive) that blends into the virtual scene context, thereby helping the user avoid the hazard without breaking the immersiveness of the VR experience. Calculations are made based on relative trajectories, and in some cases expected trajectories, to determine a timing of potential object collisions. The timing and significance of introduced deterrents (or incentives) may be modified in consideration of the threat level and immediacy of the hazard. Methods for both (i) independently coordinated collision avoidance, and (ii) cooperative collision avoidance between multiple VR players sharing a common physical space are provided. Independently coordinated collision avoidance and cooperative collision avoidance may both be implemented via respective algorithms.

VR experiences using VR headsets and add-ons, such as Google cardboard, Google Daydream View, Sony PlayStation VR, Oculus Rift, HTC Vive, Homido V2, and Samsung's Gear VR, have created a media consumption climate wherein users may become engrossed in a virtual world and become cut off or isolated from the real world around them. Immersive Augmented Reality (AR) experiences using immersive AR headsets and add-ons, such as Google Glass, HoloLens, and castAR, Intel Vaunt smart glasses, and Mixed Reality (MR) experiences using MR headsets and add-ons such as Magic Leap, Meta, Windows Mixed reality, Samsung HMD Odyssey, and others may also immerse users in virtual content and isolate them from the real world. Content capture technologies such as RGB-D sensors and light field cameras may be used or incorporated with VR, AR, and/or MR headsets to produce and deliver immersive content. Isolation and immersion are, of course, prime objectives of VR. However, many VR games and environments invite the viewer to move around. Thus, VR users may be subject to real-world hazards such as walking into walls or furniture, falling down steps, tripping on toys, or running into other real-world objects around their home or office environment while engaged in a VR session. Users may also encounter other hazards such as (potentially in-motion) real-world bystanders and other VR players. Users sharing a common real-world space may play different VR games, a shared instance of a single VR game, separate instances of the same game, etc. Additionally, the physical, emotional, and cognitive demands of some VR environments can create real-world physical stresses that can be dangerous to users (e.g., overexertion for users with high blood pressure). For some users, it may be detrimental to miss certain digital communications, such as text messages, instant messages, emails, phone calls and the like that may occur in the real world but may be missed due to the isolated and immersive nature of the VR experience.

Some features have been added to VR headsets that provide the user with some awareness of the real world around them, but these features detract significantly from the VR experience. The Chaperone mode in HTC Vive Pre's recent release allows a user to see an outline of real-world objects overlaid on their virtual reality view when they come close to the real-world objects.

The HTC Vive “peek-thru” mode is even more distracting to a VR user, in particular because entry into the “peek-thru” mode is not automatic, but must be consciously activated by the user, suggesting a further distraction from the immersion of the game as well as a potentially deadly delay in the user's ability to assess the true nature of a dangerous hazard (e.g., such as when a VR user is running straight towards an open stairway).

In some devices, a user may be running towards a wall, for example, and be warned, based on proximity only, and therefore no sooner than a different user who is inching slowly towards that wall. The result is that the running user will smack into that wall because they did not have enough time to react to the hazard, even though the walking/inching forward user has plenty of reaction time. Not only are these problems potential dangers for users, but manufacturers of VR devices are more likely to come under scrutiny or lawsuit if their devices pose these risks.

One of the key benefits of VR is immersion. Fundamentally, solutions may provide some ability for a VR user to determine if they are close to an obstacle in the real-world while using a VR device as mentioned briefly above, but they do so by taking the user out of the VR experience. Taking a user out of an immersive VR experience may be undesirable in some applications and situations.

In the case of the HTC Vive, the user is “alerted” to a real-world obstacle by overlaying a blue outline of the real-world obstacle on a VR scene when the user is within a threshold distance to the obstacle. A blue outline of a real-world table appearing out of nowhere in the midst of a virtual medieval battle zone would feel completely out of context and would be very distracting to a VR user, effectively “breaking” them away from the immersion and spoiling the fun of the VR session. Similarly, out-of-context appearances during therapeutic VR sessions can diminish the effectiveness of the therapy.

Exemplary methods and systems disclosed according to some embodiments herein help a VR user avoid potential real-world hazards without taking the VR user out of a VR session scene context. Various embodiments of the present disclosure are discussed in the balance of this Detailed Description.

While many of the embodiments disclosed herein are described reference to Virtual Reality (VR) devices and experiences, the embodiments disclosed may also be applicable to, or in some embodiments extended to, Augmented Reality (AR) devices and experiences. For example, immersive AR devices and experiences may share many aspects with VR devices and experiences such that many of the embodiments disclosed may be advantageously applied. The embodiments disclosed may additionally be applicable to, or in some embodiments extended to, Mixed Reality (MR) devices and experiences. For example, MR devices and experiences may share aspects with VR and/or AR devices and experiences such that many of the embodiments disclosed may be advantageously applied.

For example, in many mixed reality and AR applications, the augmentation is focused on particular objects in a scene, for example language translation of a sign in an AR environment, where a user's intensity of focus on the sign may cause him or her to lose track of other hazards in the environment, such as an oncoming bus or vehicle. In such cases, for example, the focus of attention may be utilized for hazard avoidance. An example may include adding an incentive or deterrent into the region of focus or even replacing the region of focus with a deterrent or incentive.

In this application, numerous examples of VR, AR, and MR devices have been mentioned, e.g., the Sony PlayStation VR, the HTC Vive, the Oculus Rift, Google Daydream View, Windows Mixed Reality, Microsoft HoloLens, and Samsung Gear VR, to name several. In some embodiments, processing may be developed to interface with a particular device's application programming interfaces (APIs) and/its software development kits (SDKs), such that, for example, calls to functions developed for the APIs/SDKs may be utilized in accordance with methods and systems disclosed herein.

This disclosure describes systems and methods for providing an in-context notification of a real-world event within a VR experience. One embodiment takes the form of a process that includes generating a VR scene using a VR headset in a real-world VR viewing location. The process also includes identifying a real-world event in the real-world VR viewing location. The process also includes, determining a context of the VR scene. The process also includes modifying the VR scene in response to the identified real-world event, wherein the modification is stylistically consistent with the context of the VR scene. In certain embodiments, the real-world event is a potential collision between a user and a stationary or moving object within the real-world viewing location. In at least one such embodiment, modifying the VR scene in response to the potential collision comprises displaying a virtual-deterrent object within the VR scene.

Another embodiment takes the form of a system that includes a communication interface, a processor, and data storage containing instructions executable by the processor for causing the system to carry out at least the functions described in the preceding paragraph.

One embodiment takes the form of a process that comprises (i) detecting an imminent hazard in the real-world, (ii) determining the VR scene context, (iii) determining an appropriate collision avoidance tactic, and (iv) displaying an in-context visual and/or auditory deterrent in the VR-scene that blends into the scene context while effecting the tactic. This embodiment may incorporate artificial intelligence or neural network techniques to determine appropriate collision avoidance tactics.

Another embodiment takes the form of a system that includes a communication interface, a processor, and non-transitory data storage containing instructions executable by the processor for causing the system to carry out at least the functions described in the preceding paragraph.

In some embodiments, the hazards may be categorized based on their degree of potential danger, and deterrents are then determined based on the degree of danger of the hazard and the immediacy of the danger.

In some embodiments, the scene context may be determined by accessing a database of scene descriptors with major and minor categories, wherein the major category is based on a top-level genre of the game and the minor category includes color and texture palettes. Top-level genres could be, for example, modern, medieval, city, country, ocean, outer space, futuristic, steam punk, office, home, etc.

Imminent hazards and the relative time of relevance and priority of those hazards may be detected and calculated, using inputs from and procedures, as applicable from any logical combination of sonar, lidar, radar, stereo vision, motion tracking, artificial intelligence (AI), and/or object recognition and may leverage existing algorithms for 2D and 3D motion vector generation and collision avoidance, including those developed for autonomous vehicle relative-motion analysis.

In at least one embodiment, the deterrents are selected from a database of objects associated with the VR program. The database of deterrents associated with typical hazards for each major VR game or game category may be populated by a team of analysts and provided as a service to VR game manufacturers. In such a scenario, the game manufacturers may subscribe to the service. Alternatively, the deterrents may be provided by the manufacturers themselves, potentially conforming to an agreed upon standard. Adherence and support of the VR collision avoidance standard would be a product differentiator of VR games/systems for parents and players.

In some embodiments, the users response to the deterrents is measured. If the measured response is insufficient to protect the user, an automatic “peek-thru” to the hazard is provided. Responses are sent to a learning engine for improvement of effectiveness of deterrents and/or learning appropriate timing for introduction of deterrents to avoid problems.

When an exit to the real world (e.g., via a “peek-thru” type mode or context-violating alarm or immersion breaking deterrent) is called for by the risk level of a hazard, a “peek-thru” effect may be overlaid with an augmented reality highlight of the hazard, so the user may quickly determine a work around and return to game play.

Initiation of “peek-thru” mode or game freeze or other out-of-context warnings may be implemented in the present systems and processes. Utilization of these out-of-context warnings, however, may be provided as feedback to the system, for use in adjusting the deterrent algorithm to introduce deterrents earlier in the timeline of a hazard scenario, for example. In some embodiments, in extreme cases, wherein it is necessary to break immersion, it is done automatically and the session is recovered automatically when the hazardous situation is remedied, thus minimizing the inconvenience of the interruption even under very high-risk hazard situations where an out of context warning is necessitated.

In many embodiments, the breaking of immersion is taken as a feedback input to the deterrent/incentive introduction system to learn, modify, and improve the timing of the introduction of deterrents, e.g., as feedback training to an AI neural network.

In some advanced embodiments, a second degree of motion prediction may be used for autonomous objects (e.g., other players) that have the potential to change direction at will (e.g., based on game play, boundaries, or their own encounter with warnings/deterrents associated with hazards). For example, if a first user is closing in on a second user who is approaching a wall (and the second user has potentially received a deterrent generated by the second users system), the second degree of motion prediction anticipates that the second user may be warned about the wall and change course to avoid a collision, with the potential for changing direction into the first user. Or the system of the first user may determine that the second user apparently has not received nor heeded a deterrent within his own VR system and will hit the wall and bounce off it at a particular angle. In some embodiments, the system may incorporate second degree of motion prediction to address such issues.

In certain embodiments, independently coordinated collision avoidance is implemented. For example, in embodiments where no direct communication is available between VR systems sharing the same physical space, there is a set of common rules that are employed by each system independently to avoid collision. For example, one such common rule is the right hand traffic (RHT) rule. This is modeled after the roadway rule in the US that states that all traffic on bidirectional roads must stay to the right. As adapted for independent but coordinated collision avoidance in VR systems, two VR players headed directly at each other are independently directed (by deterrents and or incentives generated by their individual VR systems) off to the right to avoid collision. A left hand traffic rule (LHT) could alternatively be implemented as a common rule, mutatis mutandis. In some embodiments, other types of common rules may be used as applicable such that both sides are using generally the same collision avoidance rule. It should be noted that the application space being addressed here is not specifically designed for a shared virtual world between users where collision avoidance might best be implemented by allowing each user to see the other and take normal evasive action to avoid collision. Instead, the discussion here is primarily with regard to two players that are sharing the same physical space. It assumes they are attempting to avoid a collision given they are running two different VR apps or even the same VR app but each having a unique instance of the VR space (e.g., same game, same physical space, but not a shared virtual space within the game). Even in a shared virtual and physical space environment, such rules may be implemented to complement the users' intrinsic survival/collision avoidance instincts. For example, consider that two players may be backing into each other. In such a case, deterrents, or more specifically in this case incentives, may be beneficial to help the users avoid collision.

In certain embodiments, where users share the same physical space but different virtual spaces, deterrents and incentives/attractors may be rendered that are viewable by both participants to maintain a consistent gameplay context for both users, or different incentives/deterrents may appear to each player as the former scenario provides the additional complication of avoiding a deterrent/incentive intended for a first user being acted upon by a second user with an unintended consequence. As an example, if two users are rushing towards each other in a military-themed VR game, dropping a bomb deterrent between them that they both see may avoid a collision between the two, but if a deterrent is placed to the left of the right-to-left moving user, it may cause that user to veer to his right, but if also viewed by a left-to-right moving user, it may also cause him to veer to his left and run right into the other user.

In some circumstances, two users may share the same physical space and the same virtual space (e.g., within a multiplayer VR system) wherein they are headed for collision in the physical space but not necessarily in the virtual space (simply because the virtual world and physical world are not equally scaled and/or the virtual and physical worlds are not geographically calibrated, aligned or synced). In this case each headset may still detect independently a physical-world collision and implement independently the RHT (or other) rule. The RHT rule may be implemented using a RHT rule algorithm. However, some anomalies may arise, if, for example, two people are running towards each other, and their virtual selves are far apart but their physical selves are about to collide. In this case, each headset may still render its own deterrent per the RHT rule but it may be up to the common VR system to determine if one players deterrent is visible to the other player.

In certain embodiments, cooperatively coordinated collision avoidance is implemented. In some embodiments, a means for communicating a deterrent/inventive protocol is provided between the users of independent VR systems. Collision avoidance between two players may be coordinated and deterrents in respective VR systems are generated in coordination to avoid collisions while minimally impacting game play for each user or minimizing the sum impact on gameplay of both users. For example, in non-coordinated deterrent generation where two players are running toward each other, each system may generate a virtual flat wall of fire in front of each user, requiring each user to stop dead in his tracks to avoid the flames. However, in a coordinated system, a master can be chosen and a less intrusive approach may be implemented for both or one of the users. In some embodiments, a metric is associated with the impact on immersion and the values of this metric associated with various deterrents may be used to alternate between having a first user experience a minimal impact and the second user experiencing a minimal impact. In this way, rather than each user taking a significant deterrent on each joint collision avoidance instance, the significant deterrent occurrence may be ping-ponged back and forth between the users, decreasing by at least half the occurrence of significant impacts to gameplay for each user, while still avoiding the collision as effectively. For example, in a coordinated/communicative system, two proximate users' systems may handshake over a communication channel, choose a master system and coordinate potential collision avoidance. For example, if the user of the first system (determined to be master) approaches from the West toward a second user approaching from the East, the system of the first user may create a virtual pit to the North of the first user, forcing the first user South-East, and the system of the second user may be instructed by the master (first system) to take no action, thus reducing the impact to the gameplay of the second user. Note that non-coordinated implementations under the RHT rule would direct both users to their respective right, while the coordinated system may alternate which user gets affected and thus may mitigate the severity of collision avoidance deterrents/incentives. In the cooperatively-coordinated embodiments, collision may be avoided with a less severe deterrent required and a less significant adjustment on the part of the user's trajectory relative to a non-cooperatively-coordinated implementation.

In some embodiments, a first system that implements cooperatively-coordinated hazard avoidance may share the same physical space with a second system that also implements cooperatively-coordinated hazard avoidance, but the second system may implement an option for its user that allows the user to select an option to (a) completely avoid the use of hazard avoidance deterrents/incentives or (b) to control the maximum degree/significance of deterrents/incentives that may be used. This feature may be provided by the second system to allow the user to operate with minimal distraction in a relatively safe environment. If the first system communicates with such a second system, it will recognize to what degree if any the second system will be using deterrents for its user and adjusts its first user's deterrents accordingly. This may be useful when the first user is, for example, demonstrating the VR experience to the second user or is using the systems therapeutically for the second system user.

If the players are part of the same multiplayer VR game, these deterrents can be controlled by a cooperative node of the processing system for that game. If the users share the same virtual space, virtual representations of the users themselves may be used as deterrents, in some cases, with speed and distance exaggerated to provide sufficient buffer for reaction time. If the players are using independent VR systems and playing independent games, a standard for communication (e.g., Wifi/Bluetooth with autoconnect mode), a low-level protocol (e.g., TCP/IP) and an application layer protocol (e.g., [timestamp: master command]) may be used for transferring collision avoidance tactics between systems. Each game manufacturer would be encouraged to conform to such a standard practice and each system would generate a deterrent/incentive based on their own VR context but may choose one master between the various systems to identify the diversion tactic to be employed by each system.

In one communicative/coordinated embodiment, each of the proximate user's systems establishes a bidirectional communication channel between them. The VR devices use this channel to establish a hazard avoidance master, then the hazard/collision avoidance master calculates and determines its own hazard avoidance tactic (if any is necessary) and communicates it to the hazard avoidance slave partners. It is then up to the slave partners to decide on a complementary collision avoidance tactic to implement if any. The slave may communicate its planned tactic, and/or the master may update its tactic. In a basic implementation, the communication channel may carry a protocol of couplets between the master and slave such as [implementation time: tactic] wherein implementation time may be the time the communicating system intends to implement the deterrent/incentive and tactic is the planned effect of the tactic on the user of the sending system (e.g., deter right, stop, slow, deter left, pull left, pull back, pull right). The receiving system (slave) may then use this information to plan its own tactic, if any. Alternatives include the master making the decision for the other systems (slave systems) and communicating that but not its own tactic, or the master communicating tactics for both systems (so there can be no ambiguity). In alternative examples, implementation time may be replaced by effective time.

In some coordinated and communicative systems, anticipated changes in the direction and location of a user may be communicated to the paired system. For example, if information is available to a first system that the scripted gameplay of that system will imminently cause the user of that first system to jump suddenly to the right, this may be communicated to the paired proximate system to use in its collision avoidance strategies, since without this information, it would be calculating collision avoidance based on a motion prediction model based on a continuation of a current motion trend. Such a protocol may look like [ESC, time, anticipated action], where ESC is a special code that signals an imminent unexpected direction change, time is the anticipated time of the change, and anticipated action is the anticipated change in direction or location (e.g., jump right, jump left, jump back, stop short, jump forward, steer right, steer left). Determining the direction of travel of a user and the reactionary movement of a user can be based on heuristics of gameplay that describes patterns and paths followed by typical users over time. Furthermore, the reactionary movement may be determined using a script of planned gameplay. An object detection algorithm and path selection algorithm, such as those used by autonomous vehicles, may be used to analyze a VR game scene and predict a users movement in advance of it happening.

For example, a VR user that is driving a car in a game that requires the driver to take a real-world step in the direction of travel to effect a turn in the virtual car, would be expected to take a step to his right in the physical world when/if that user's game indicated a bank to the right in the virtual-world road. In such cases the app may be developed in such a way that it may output such bends in the road in a way that can be interpreted by an external module to determine the user's imminent reaction, or it may output the anticipated reaction in advance. In fact, most games in development have pre-calculated the user actions and game counter-actions for all sorts of scenarios. In some embodiments, this information may be further processed to produce the collision avoidance deterrents/incentives. As another example, a first user may be running through a virtual reality maze approaching a sharp right turn in the maze causing him or her to make a sharp right in the physical world that likely could not be anticipated by a proximate system of a second user. However, this information may be of significant value to the second VR system to anticipate the motion of the first user.

In some embodiments, in addition to velocity, distance, and second degree considerations such as evasive action of other autonomous objects, a third degree of motion prediction is used, based on trends in velocity (e.g., acceleration/deceleration). The acceleration/deceleration of another real-world object and/or the user himself may be used in calculating the potential for and immediacy of a hazard and therefore used in the calculation of when and with what severity a deterrent should be introduced.

In one embodiment, a VR or AR system determines and prioritizes potential hazards to provide a warning for said hazards “in context” of the VR or AR session.

In various embodiments, a method may use a plurality of sensors combined with signal processing to determine imminent hazards. In some of these embodiments, depth sensing or image processing techniques such as edge detection and detection of discontinuities are used, potentially in combination with other sensors, to determine if uneven floors, changes in floor level, carpets or other obstacles are in a user's path.

In some embodiments, H.264 compression related motion vector hardware and/or software are modified to determine the speed and direction of objects within the field of view and identify objects that the user may imminently collide with or vice versa. Determining speed and trajectory provide information for setting the need for and priority of deterrent events and notifications. If a user is close to an object but moving away from it, no deterrent is needed. However, if two users are moving towards each other, the deterrent and/or the presentation of that deterrent may need to be twice as significant/severe and/or presented much earlier than if the scenario only involved one user moving toward a stationary person/object. If a user is moving at an angle to a wall, for example, the component of the velocity vector that is normal to the wall's surface may be used to determine the time at which a deterrent should be rendered to prevent the user from running right into the wall.

In many situations, it may not be realistic for deterrents to simply appear from nowhere unless the dynamics of the game were so fast moving and the potential hazard was so severe that such a deterrent was required. Thus, many embodiments involve the early integration of the seeds of deterrents in areas that may be potential hazards. For example, if the system detects that a staircase is to the users right, it may render a smoldering car in that direction in the distance even before the user moves in that direction or before the stairway presents itself as a hazard. If it looks like the user is starting to make his way in that direction, as the user approaches, small sparks and small flames may be seen and the smoking may increase. If the user decides to head right in the direction of the real-world hazard, dripping gasoline may be exposed from the smoldering car crash deterrent and if he continues, with pace and direction such that he may imminently head over the real-world threshold of the open stairwell, the car may burst into flames in an inferno, thus deterring the user from closer approach. In each case, the severity level of the deterrent and the timing of that severity level is not just a function of the simple distance of the user to the hazard but also his velocity (and potentially acceleration) in that direction. In some embodiments, if all deterrents fail and the user continues into a dangerous real-world hazard (such as an open stairway), gameplay may be halted and an out of context warning may need to be presented as a last resort. For example, in rare circumstances some users may want to virtually experience a deterrent, mistakenly not heeding the object as a hazard but rather as a part of the VR experience.

In some embodiments, additional factors may be used to determine the timing and severity of a rendered deterrent. For example, a decision engine/likelihood determination engine may be employed to determine the likelihood that a user may turn in the direction of a potential hazard and this decision engine may be used to determine the priority of deterrent generation and presentation. The engine may have, at its disposal, information regarding the VR game or script. For example, in a forest VR representation, a user may be strolling leisurely through the forest along a path toward a potential real-world hazard (e.g., a wall in his real-world apartment), his pace not warranting the triggering of a deterrent for that hazard (a) because there are multiple paths the user may take before reaching the hazard that would not lead him to hazard, and a path avoiding the hazard is determined to be more likely than one encountering it, and/or (b) the deterrent generation system has information indicating that the game, per its script, will shortly render a small family of friendly sentient raccoons to the user's left, drawing the user away from the hazard without need for intervention. Thus, in some embodiments, the disclosed process uses information regarding the VR system scene or anticipated scenes as part of the deterrent necessity prediction algorithm. In some embodiments, if, for example, a user is close to a real-world wall on his right and the script of the game play includes the appearance of a scary avatar on the user's left which may cause the user to jump to the right and smack into the wall, a deterrent may be inserted into the game or an alternative script that is more compatible with the real-world context may be selected by the game for continuation.

In some embodiments, heuristics of game play and genre of game are considered in dynamically setting the importance of potential hazards and deterrents. During relatively calm game play, where rapid changes in direction are not anticipated, the threshold for deterrent display or more significant alert action is higher than in situations where rapid movement is typical and is more likely to be imminent.

In certain examples, the degree or severity of a potential hazard is also calculated as well as a user's response to the virtual in-context deterrents. If it is determined that the user is not responding to virtual deterrent's, and a hazard/collision is imminent, as a last resort, a higher level/priority alert may be communicated to the VR user. Based on the level of potential hazard to the user, the user interface provides various levels of audible, visual, shock, and/or vibration feedback to the warn the user of the hazard. At low levels of potential hazard, the feedback is purely within context. At higher levels of potential hazard, the feedback becomes more prominent. In various embodiments, each level of danger is associated as well with a combination of vibration and audible level warnings, a combination of speech and alarm sounds.

In at least one embodiment, detecting higher levels of potential hazard automatically trigger a “peek-thru” into the real-world with an augmented reality overlay of the hazard in the real-world environment. In some embodiments, wherein a “peek-thru” to a potential hazard occurs, once the potential hazard is minimized (e.g., the user slows or changes direction), the “peek-thru” effect is automatically removed.

In some embodiments with numerous players, a centralized or decentralized component of the deterrent module may utilize swarm algorithms to deal with collision avoidance of many players simultaneously, wherein the players and their obstacles are fed into the algorithms. A particle swarm optimization result (e.g., a result of the swarm algorithm(s)) may be used to anticipate the change in direction or the response to the change in direction.

In one embodiment, a standard software stack represents each VR system. In one embodiment, each deterrent engine is a module within a VR OS and a VR App sits on top of the VR OS (and reaches down thru calls for standard resources). Each App exports a database or library of deterrent objects to the deterrent engine, which is theme-consistent with the App. Deterrent objects are categorized by severity/significance and depending on how varied the scenes are within the game, the deterrents may be further categorized by scenes within the VR App. For example, a racing game that goes from tropical to desert scenes within a VR App may export scene change IDs dynamically with scene changes (or sufficiently in advance of scene changes for changes to be effected) and the deterrents available for selection may be subcategorized by those scenes.

In various embodiments, real-world time sensitive interrupts such as phone calls, text messages, email messages and related are translated into in-context events in the virtual world.

In one significant embodiment, the system disclosed herein integrates health monitoring sensors for heart rate, breath rate, oxygen and other physiological signals that can indicate high levels of distress. The system modulates an intensity of game play. The hazards to avoid include physiological extremes (e.g., high levels of distress) as indicated by the various health monitoring sensors. This avoidance may be accomplished using deterrents against intense activity that are inserted into the game play but which match the theme of the game so the immersion is not broken. One example includes dropping an old metal cage over a player of a dungeon game during a dragon battle, responsive to a heart rate sensor exceeding a threshold maximum value. The cage prevents the VR-game dragon from being able to attack the player, affording the player of the game a few moments to relax (without breaking the immersive experience). Similarly, preconditions for certain ailments and metrics reflecting the risk of the game play triggering those ailments (e.g., a heart attack) may be used to modulate the severity of deterrent chosen and how quickly it is introduced to a virtual scene. In the previous example, this could be accomplished by gradually lowering the cage from the top of the player's view commensurate to the desired severity. A max severity would be represented by the cage being fully lowered.

Moreover, any of the embodiments, variations, and permutations described in the preceding paragraphs and anywhere else in this disclosure can be implemented with respect to any embodiments, including with respect to any method embodiments and with respect to any system embodiments.

FIG. 2 depicts a flow chart of a method, in accordance with at least one embodiment. In particular, FIG. 2 depicts a process 200 that includes steps 202, 204, 206, and 208. At step 202 the process 200 includes generating a VR scene using a VR wearable display device (for example, a “VR headset”) in a real-world VR viewing location. At step 204, the process 200 includes identifying a real-world event in the real-world VR viewing location. Some examples of identifying real-world events include detecting hazards such as, e.g., potential collision between the user and an obstacle, or other events, such as receiving inbound digital communications, and sensing that a threshold value of a physiological state has been surpassed. At step 206, the process 200 includes determining a context of the VR scene. In some embodiments, context may be determined by accessing a database of scene descriptors of the current VR application and/or current VR scene, where such scene descriptors may include information such as genre as well as color and texture palettes. In some embodiments, context may be determined by accessing a database or library of VR objects that are associated with the context of the current VR application and/or scene and, for example, the 3D coordinates of the user in the virtual scene as well as, for example, the 3D coordinates of other significant objects within the scene. At step 208, the process 200 includes modifying the VR scene in response to the identified real-world event, wherein the modification is associated with the context of the VR scene. For example, in some embodiments, the modification may include the generation of a context-associated VR object into the VR scene. By virtue of its association with the determined context, the generated VR object may be thematically and/or stylistically consistent (e.g., context-appropriate) with the VR scene. Thus, a context-associated VR object may include, e.g., a context-appropriate VR object. Such a configuration may allow the VR user to be alerted about real-world events while, e.g., preventing the user from “breaking out” of the immersive VR experience.

FIG. 3 depicts a first example VR system, in accordance with at least one embodiment. In particular, FIG. 3 depicts a VR system 302 that comprises both hardware and software. The VR system 302 includes a VR operating system 304 and various VR applications 306A-C which may be run using the VR system. It is noted that the VR system may include a plurality of VR applications and is not limited to the number of applications that are depicted in the figures as to provide context. In FIG. 3, the VR operating system includes a deterrent generation module 308. The deterrent generation module is in communication with each of the VR Apps 306A-C.

FIG. 4 depicts the example VR system 302 of FIG. 3 further comprising an incentive generation module 410, in accordance with at least one embodiment. In some embodiments, an incentive generation module is in communication with each of the VR Apps 306A-C. Incentives may be utilized along with deterrents for modifying a given VR scene.

FIG. 5 depicts a fourth example VR system, in accordance with at least one embodiment. In particular, FIG. 5 depicts an exemplary architecture for a VR system with in-context collision avoidance capabilities. The VR System 502 of FIG. 5 includes both hardware and software.

The hardware comprises collision sensors 508 and other hardware 510. The collision sensors can be any logical combination of cameras, stereo cameras, depth cameras, IR cameras, LIDAR, radar, sonar, ultrasonic, GPS, accelerometer, and compass. The other sensors may include a barometer, heart rate sensor, galvanic skin sensor, blood pressure sensor, EEG, etc. The system can include various communication hardware such as wireless radio, LTE, Bluetooth, NFC and the like. A hardware abstraction layer 512 is provided to refine the raw data from sensors into more usable information.

A deterrent generation module 514 in the VR operating system 504 receives coordinates of potential obstacles from hardware collision sensors built into the system. It determines priority and severity of deterrents that may be needed based on rates and direction of movements of the user, other users and obstacles, and sends a request to a database of theme-specific objects 516, for example, deterrents or incentives, e.g., that match the theme of the current scene of the VR. The request may include the severity of deterrent that may be needed as well as category and subcategory of deterrent. This information is provided by the VR application 506, along with information about when those themes/scenes will change.

Objects selected from the database of theme-specific objects 516 are sent to the object composition engine 518 to be rendered along with the other elements of the scene. The other elements of the scene include objects from an application object library 520 that are requested by the VR App 506. Coordinates for where to place the deterrents as well as the presentation times of the objects are sent from the deterrent generation module 514 directly to the object composition engine 518 so the deterrents appear at the right time and in the right position in 3D space to help a user of the system to avoid a hazardous situation. Certain objects may include placement constraints to assist the object composition engine in the placement of the objects and to offload this responsibility from the deterrent generation module, particularly with respect to height. For example, a floating bomb may intrinsically be placed at eye level. Other standing objects like dragons may, for example, always be placed so that their feet are on the ground (unless they are flying dragons, in which case there may be a default height for them).

Information is sent from the deterrent generation module 514 to the outside world via the external communications module 522. Similarly, information from the outside world is received by the deterrent generation module 514 via the external communications module. The external communications module may be used to establish a plurality of different, potentially concurrent communications channels. One may be to a server to refresh the database of app-specific objects or load them dynamically as different apps or scenes are loaded. Another may be for reporting of the effectiveness of collision avoidance deterrents in various scenarios for improving the library. Furthermore, the external communications module 522 may be used to allow the deterrent generation module 514 to communicate with peer deterrent generation modules of other nearby VR systems for cooperative collision avoidance as depicted in FIG. 13.

FIG. 6 depicts an exemplary use case including in-context obstacle avoidance, in accordance with at least one embodiment. In particular, FIG. 6 illustrates a scenario 600 wherein a user 602 is wearing a vision-obstructing VR headset 604. The user has started walking and the system detects that the user will imminently collide with an obstacle 606 in his real-world path, in this case a table. The system determines a context of the VR scene 608 and responds by inserting a visual theme-related deterrent 610 into the user's path. For example, in a dungeon-themed VR experience, a VR generation engine may create an image of a giant spider and web that falls down into the user's virtual path to deter further movement by the user in that direction. Additionally or alternatively, the present system may mix a verbal theme-related message into the audio stream such as “Stop, large venomous spider ahead” instead of or in addition to the visual overlay, using an emulation of voice encodings of a narrator or character from the VR environment. In some instances, the deterrent may accompany the visual image with a loud hissing sound representing the breathing sound of the spider. In other examples, the obstacle in the users path may be a moving object, in which case the relative velocity and potential for collision based on the object's motion vector is used to determine what level severity of deterrent must be displayed and when and where the deterrent must be displayed.

FIG. 7 depicts an example use case including in-context communication alerts, in accordance with at least one embodiment. In various embodiments, real-world time-sensitive interruptions such as incoming digital communications (including, for example, phone calls, text messages, urgent email messages, news, weather, or emergency reporting messages, and the like) are translated into in-context events in the virtual world. As illustrated in FIG. 7, a VR wearable display device 706 identifies an incoming digital communication 704 and alerts the user 702 by displaying a context-appropriate modification 708 to the VR scene. In some embodiments, incoming digital communication is received via the external communication module 522 which may be configured to receive the relevant information through one of its communication channels. Many creative means for displaying the communication may be utilized as in-context events. For example, the VR wearable display device 706 may alert the user of incoming communication by generating a VR object that represents a characteristic of the digital communication, such as the sender of the digital communication. In some cases, the VR object alerting the user of incoming digital communication is displayed with associated text. The text may represent characteristics of the communication such as the type of digital communication, the sender, and/or text belonging to the incoming message. For example, FIG. 7 depicts a Dungeons & Dragons VR session 700 wherein a VR user 702 receives an incoming call from the VR users mother. The alert to the VR user may be represented by rendering a troll with a scroll. The scroll opens when the troll is centered in the display to reveal a message, written in an ancient dungeon looking font such as Papyrus (or equivalent that is in-context of the scene) that says “Your slave master has summoned you!” In another example, not shown in FIG. 7, an incoming digital message informing the user of impending bad weather might be represented in text, video, or audio, as a series of storm clouds, the sound of wind, thunder, or pouring rain, or text superimposed on storm clouds, depending on the particular context of the VR scene. These alerts may be mechanized from a database of translations that have default generic settings based on the game context but which can be customized by power users. In some cases, a color palette and texture of the present VR scene may be matched when displaying message text in a planar window.

FIG. 8 depicts an example use case scenario including physiological monitoring, in accordance with at least one embodiment. In one embodiment, the system disclosed herein integrates health monitoring sensors for heart rate, breath rate, oxygen and other physiological signals that can be monitored by mobile or stationary platforms automatically (e.g., Qualcomm Tricorder XPrize Challenge) and that may indicate high levels of distress in a user. Upon detection of a sensor surpassing a threshold value the system modulates intensity of game play. This can be accomplished using visual deterrents that are inserted into the game play but which match the theme of the game so the immersion is not broken. These deterrents can be placed so as to prevent the user from physically exerting themselves. Deterrents for modulating gameplay can also come in the form of more subtle changes in the game. For example, in a first-person fighter game, where a user fights a series of villains, more time may be inserted between the appearance of villains, thus allowing a user to rest between significant exertions. Typical symptom patterns and physiological signals for the onset of motion sickness, stress, nausea, blackouts, stroke, heart attack, behavioral changes, eye strain, fatigue, seizure, and even boredom may be monitored to determine if mitigating deterrents need to be invoked or even VR sessions terminated (or, in some cases, e.g., sped up or slowed down). In some embodiments, facial emotion recognition is used to characterize emotional state and intensity of users for prevention of psychological changing intensity level, eyestrain or related ailments.

In the example of FIG. 8, according to some embodiments, a VR user is playing a first-person VR shooter game requiring a lot of jumping and dodging when the aliens are attacking. Prior to the game starting, the user may have filled out a health profile indicating his age and weight. In the example of FIG. 8, the device may include interfaces to fitness bands and/or integrations with various physiological sensors, including those disclosed elsewhere that can sense CO2 level in blood, pulse, respiration rate, and potentially other biological stress markers (e.g., salivary cortisol or alpha-amylase). As the game progresses, the device monitors the users physiological state. As heart/respiration/blood CO2 levels surpass threshold levels, the device triggers the game to insert “slow-downs”. By inserting “slow-downs” the intensity of the game may be modulated. These “slow-downs” maintain the context of the game but represent a mitigation of the action that allows the user to regain a safer physiological state. For example, as a heart rate approaches dangerous levels, the device may signal the game to send fewer aliens, or create longer pauses between waves of aliens, or have the aliens shoot fewer lasers, allowing the user to have to dodge fewer laser blasts per second and allowing his pulse to slow down.

Detection of a sensor surpassing a threshold value is also referred to herein as the detection of a biometric parameter. It is noted that the phrase “surpassing a threshold” as used in this disclosure is not limited to a sensing a value greater than a threshold value. Indeed, depending on the rule defining the biometric parameter, “surpassing a threshold” may include, for example, sensing a value greater than a threshold value, sensing a value lower than a threshold, determining a metric based on sensor values, sensing a rate of change of a biometric parameter that is abnormal, or sensing a value, or rate of change for a biometric parameter that is abnormal relative to the users norms, or any combination thereof.

In some embodiments, detection of a biometric parameter includes reading from a health monitor sensor. One example includes receiving a read of the user's blood pressure. If the user's blood pressure exceeds or falls below a certain level, for instance a blood pressure above 140/90 (hypertension stage II) or below 90/60 (hypotension), then the VR system may insert a slow-down to modulate the intensity of the current VR program. In further embodiments, detecting the biometric parameter may include a rule combining multiple threshold values. For example, a slow-down may be inserted in response to sensing that the users blood pressure is above a value of 140/90 and sensing that the users heart rate is greater than 60 bpm. In even further embodiments, a metric could be used in determining the biometric parameter. For example, a rate-based metric “Time-to-threshold” may be calculated based on the following formula:

$$T = \frac{( Max BP - Current BP )}{Rate\_increase \_BP} \qquad Eq . 1$$

where T is Time-to-threshold, MaxBP is the users maximum blood pressure, CurrentBP is the users current blood pressure, and Rate_increase_BP is the rate of increase of the users blood pressure over time. The Time-to-threshold metric may be used in determining the biometric parameter by inserting a slow-down when the Time-to-threshold metric drops below a value, such as 10 seconds.

FIG. 9 depicts two VR users running towards a wall, in accordance with at least one embodiment. In particular, FIG. 9 depicts two people running toward a wall 902 and each other at an angle. VR1 represents the velocity vector of a first VR user 904 (“runner 1”) and VR2 represents the velocity vector of a second VR user 906 (“runner 2). Vr1,r2 is the component of the velocity vector of runner 1 in the direction of runner 2 and Vr2,r1 is the component of the velocity vector of runner 2 in the direction of runner 1. Vr1,wall and Vr2,wall are the components of the velocity vectors of runners 1 and 2 in the direction of the wall, respectively. Each component can be used to determine the relative amount of time each runner has before they impact each other and/or the wall if they will by continuing at their current velocity. The relative distances between runners and the wall are provided by analyses of various sensor data. The locus labeled Ta indicates a location of impact of the two runners if nothing changes and the locus labeled Tb indicates the general location of impact of the first runner with the wall if no deterrent is involved. The labels Ta and Tb indicate the times of impact, respectively. In this example, Ta<Tb.

If only the distance were considered in determining whether to enable a warning (e.g., a blue outline in the HTC Vive), then some hazards would not be sufficiently avoided. In that case, two people running at each other at high speed or walking at each other would get the same distance of warning, and in the running scenario, dependent on the relative velocities toward each other, the warning may not come in time to avoid a collision. In the present disclosure, however, in at least one embodiment, the time to collision is calculated (as well as direction) and a deterrent is generated with sufficient time and of sufficient severity to avoid collision at Ta.

In another embodiment, assuming both runners are VR wearers using systems that can communicate via a standard channel for collision avoidance (such as a modified DSRC system), the first runner's system may anticipate that the second runner will be displayed in the first runners system as a deterrent for collision and as a second order of collision avoidance it may generate simply a deterrent for avoiding the wall since it calculates that the second runner will be alerted to stop before she becomes a hazard to the first runner. Various other second order/degree considerations may be considered by the system and appropriate coordinated collision avoidance put into play.

FIG. 10 illustrates 2nd and 3rd degree motion prediction considerations, in accordance with at least one embodiment. In particular, FIG. 10 illustrates additional 2nd and 3rd degree motion prediction considerations. Some methods involve basic time, distance, velocity and rate of change of velocity considerations and some methods include an anticipated response of other intelligent systems and the users that are being influenced by those systems.

In a more basic embodiment involving only a first VR user 1004 (“VR user 1”) and the wall 1002, an exemplary system may employ a basic deterrent based on VR user 1's instantaneous velocity and distance to the wall, and put up a deterrent D1,1. D1,1 (a first deterrent for VR user 1) is illustrated by a dotted line that is at 90 degrees to the velocity vector VR1. This indicates a deterrent the system placed directly in the path of VR user 1 with the intention of having that user stop or avoid anything dead ahead along his direction of travel.

In a more advanced embodiment, the system may obtain a series of position data points over time or use accelerometer data and responsively determine that VR user 1 is decreasing his velocity over time, and thus the appearance of D1,1 may be delayed in time but be placed at the same position. Alternatively, the display position could be pushed further away from VR user 1 (e.g., as illustrated by D1,2). Alternatively, the system may have information indicating that the VR game has a virtual wall in substantially the same location as the real-world wall and thus, VR user 1 is likely to slow down without any deterrents added and so the system can wait and see, observe VR user 1's dynamics and assert the deterrent only if he does not appear to slow down and/or change direction. Further, if the user does appear to be slowing down due to the virtual wall that is already part of the game play, but not sufficiently, it will insert a deterrent D1,2 (a second deterrent for VR user 1) to help guide the user. Note that D1,2 is illustrated by a dotted line that is at a slight angle to the normal of VR1. This indicates a deterrent at the crossing location that may be slightly to the left of the direction of travel, suggesting to the user that he should adjust his course to the right.

Considering both users, having information that there is a wall 1002 in front of VR user 1006 (“VR user 2”), and predicting that she is likely to either (i) hit the wall and deflect off, (ii) see some outline of the wall (e.g., via HTC Vive outline mode), or (iii) be alerted to the wall by a deterrent (e.g., D2,1), the system may anticipate a collision point at the locus labeled Tc. The deterrents D1,1 or D1,2 may be appropriately adjusted by anticipating this change in direction and velocity magnitude from VR2,a to VR2,b of VR user 2.

Alternatively, a different deterrent, D2,1 may be generated, perhaps via a coordinated communication between VR systems of this type or if users 1 and 2 are players within the same multiplayer VR game that uses the technology of this invention. For example, D2,2 may be used to direct VR user 2 to change direction to the right and miss the wall to the right in conjunction with D1,2 being used to direct VR user 1 to run parallel to the wall as depicted in FIG. 11.

FIG. 11 depicts an example use of incentives and deterrents, in accordance with at least one embodiment. In particular, FIG. 11 depicts use of incentives and deterrents for directing VR user 1106 (“VR user 2”). An incentive I2,1 (e.g., a pot of gold) for VR user 2 may be combined with deterrent D2,2 (illustrated in FIG. 11 using both a dotted line and with an exemplary fire breathing dragon) to persuade VR user 2 to change direction from VR2,a to VR2,b. In some embodiments, the fire breathing dragon is not visible in the VR rendering for VR user 1104 (VR user 1) while in other embodiments it is.

Throughout this disclosure, the term deterrent has been used to describe something that would deter a user from doing something (e.g., moving in the direction of a hazard). However, in some embodiments, rather than a deterrent in the path of a user, an incentive may be used off to the side of a hazard or a combination of deterrents directly in the path of a hazard as well as incentives off to the side of a hazard may be employed to encourage a user to avoid a hazard. Incentives may be used, in many circumstances, in place of or in addition to deterrents. Discussions of deterrents throughout this document may be replaced with discussions involving incentives, mutatis mutandis.

FIG. 12 highlights an exemplary independently coordinated hazard avoidance scheme, in accordance with at least on embodiment. In particular, FIG. 12 depicts the case wherein two human players are sharing the same physical space, and wherein each players' system independently facilitates the generation of deterrents in order to avoid collisions. As illustrated, two users in a shared physical space 1202 detect each other moving toward each other and start to determine an anticipated time of potential collision. Each user's VR system independently selects an appropriate deterrent from a context specific database of deterrents for their application and renders it in an appropriate location within their independent virtual spaces 1204 and 1206 (unseen by the other user). In scenes 1208 and 1210, the two users can be observed responding to the deterrents to avoid collision. In embodiments where no direct communication is available between VR systems sharing the same physical space, there is a set of common rules that are employed by each system independently to avoid collision. For example, one such common rule is the right hand traffic (RHT) rule illustrated in this example. This is modeled after the roadway rule in the US that states that all traffic on bidirectional roads must stay to the right. As adapted for independent but coordinated collision avoidance in VR systems, two VR players headed directly at each other are independently directed (by deterrents and or incentives generated by their individual VR systems 1212 and 1214) off to the right in their respective directions of travel to avoid collision.

FIG. 13 depicts two VR users and corresponding VR systems in communication with each other, in accordance with at least one embodiment. In particular, FIG. 13 depicts the case wherein two human players are sharing the same physical space, and wherein each players' VR system comprises a deterrent generation module. The deterrent generation modules are in communication via a communication path. In such an embodiment, cooperative collision avoidance tactics may be employed such as those described with respect to FIG. 14.

FIG. 14 depicts a flow chart of a multi-device collision avoidance method, in accordance with at least one embodiment. In particular FIG. 14 depicts a process 1400 comprising steps 1402-1412. At step 1402 the process 1400 includes identifying other VR systems in the same physical space. Proximity sensors, image sensors, GPS sensors, and wireless communication protocols may all be utilized to detect nearby devices. At step 1404 the process 1400 includes establishing a communication channel with each nearby VR system. This may be done via Bluetooth, NFC, Wi-Fi or related protocols. At step 1406 the process 1400 includes determining a collision avoidance master and slave for each pair of VR systems. At step 1408 the process 1400 includes determining if a collision is imminent between any two systems of a pair. If a collision is not imminent the process will wait at step 1408 until a collision is imminent. If a collision is imminent the process moves on to step 1410. At step 1410 the process 1400 includes the master VR system calculating its own collision avoidance tactic and communicating this to the slave. The master will inform the slave of an implementation time for the selected tactic and then the master returns to step 1408 and awaits further imminent collision detections. At step 1412 the process 1400 includes the slave determining its own collision avoidance tactic in view of the master's plans. The slave may or may not inform the master of its plans.

FIG. 15 depicts a flow chart of a method, in accordance with at least one embodiment. In particular, FIG. 15 depicts a process 1500 that includes steps 1502, 1504, 1506, and 1508. At step 1502, the process 1500 includes rendering initial VR views to a VR user using a VR wearable display device in a real-world VR viewing location. At step 1504, the process 1500 includes detecting a mobile real-world obstacle in the real-world VR viewing location. At step 1506, the process 1500 includes detecting a potential collision between the VR user on a current trajectory and the mobile real-world obstacle on a second trajectory, wherein the current trajectory intersects the second trajectory. At step 1508, the process 1500 includes, in response to detecting the potential collision, rendering, at a display of the VR wearable display device, a context-associated VR object in a VR view, wherein the context-associated VR object is configured to divert the VR user from the current trajectory of the VR user and to avoid the potential collision.

Detecting a mobile real-world obstacle in the real-world VR viewing location, as depicted by step 1504, may involve using sonar, lidar, radar, stereo vision, motion tracking, artificial intelligence based detection, and object recognition. The process 1504 may utilize a system with collision sensors and a hardware abstraction layer, such as the one illustrated in FIG. 5, to collect sensor data and refine the sensor data into usable information. In some embodiments, this process may leverage existing algorithms for 2D and 3D motion vector generation (e.g., those in use in advanced MPEG compression or graphics systems) and calculating trajectories.

Detecting a potential collision between the VR user and the mobile real-world obstacle, as depicted by step 1506, involves determining the potential for intersection of the trajectories of the VR user and the mobile obstacle. It can be noted that the trajectories are not limited to being represented with lines. Each of their trajectories, as well as the VR user and/or the mobile real-world obstacle, may be defined to include a width, area, volume, range, curve, arc, sweep, or a similar parameter. In this way, trajectories may be determined to intersect even if the calculated motion vectors of the VR user and mobile object suggest proximity but do not strictly intersect.

In some instances, a potential collision is detected between the VR user and a second VR user. In some embodiments, a collision between multiple VR users is avoided by having each VR headset independently generate deterrents based on a set of shared rules. An example rule set that is shared between the VR users wearable devices is shown in FIG. 12 by the implementation of the Right Hand Traffic Rule.

In some embodiments, collision is avoided cooperatively by establishing communication between VR wearable display devices and exchanging cooperation information, as illustrated in FIG. 14. In such embodiments, VR wearable display devices may communicate according to a standardized signaling protocol compatible with both displays. Such a protocol may be used to share information such as the time of an anticipated collision along with a planned tactic for avoiding collision. In some embodiments, e.g. embodiments with motion prediction implemented, a signaling protocol may be used to communicate anticipated changes in motion from one VR wearable display device to another. In some embodiments a bidirectional communication channel may be established to select a collision avoidance master and a collision avoidance slave, wherein the collision avoidance master determines cooperation information and communicates it to the slave. In some embodiments, the collision avoidance master determines the slave's avoidance tactics and communicates them to the slave. In other embodiments, the slave determines its own avoidance tactic after receiving the masters tactic. In some such embodiments, the slave may communicate its determined collision avoidance tactic back to the master.

In response to detecting a potential collision, the process includes rendering a context-associated VR object in a VR view to the display of the users VR wearable display device, as depicted by step 1508. A context-associated VR object has the property of being stylistically consistent with the theme/context of the VR scene, or otherwise associated with the context of the VR scene as previously described in this disclosure. In some instances, the context-associated VR object may be rendered at a position in the VR user's view that corresponds to the position of the real-world obstacle. For example, the deterrent generation module, as shown in FIG. 3, may render a deterrent at the position of a real-world obstacle to warn the user of a potential collision at that location and guide the user to change their trajectory. In some embodiments, a context-associated VR object may be rendered at a position corresponding to the current position of a mobile real-world obstacle, so that the rendered object moves in accordance with the real-world obstacle. In some embodiments wherein the obstacle is another VR user and wherein the VR users share the same physical space for their VR viewing location, deterrents are rendered on the display of the VR user at the position corresponding to the location of the other VR users. In these real-world physical shared-space situations, VR objects representative of the VR users (e.g., avatars associated with the users) may be used as deterrents.

In other cases, the context-associated VR object may be rendered in the VR user's view at a position other than that corresponding to the real-world position of the obstacle. In one example, as illustrated in FIG. 10, a deterrent may be generated at a position closer than the real-world position of an obstacle in order to change the user's trajectory to make room for another VR user. In another example, as illustrated in FIG. 11, a VR object may be rendered at a position different from (e.g., far from) the obstacle if the VR object is an incentive configured to divert the VR user away from a potential collision and toward the incentive. In some embodiments, a VR object may be rendered at a position corresponding to a predicted location of the mobile obstacle. For example, in a shared VR space, a VR object may be rendered to a first VR user at a predicted location of a mobile second VR user, thus rendering a VR object not at the current position corresponding to the second VR user, but rather at a position where a potential collision between the VR users may occur.

The rendering of a context-associated VR object may be based in part by a severity of the potential collision/hazard. In at least one embodiment, severity is determined based on the sensor data from the hardware sensors. Severity may be based on distance and/or velocity between the VR user and the obstacle or may be determined from calculated motion vectors. Potential collisions that are determined to be more imminent may have a higher severity. In some embodiments, severity may be based at least in part on a calculated likelihood of collision. In some embodiments, severity may be based at least in part on characteristics of the obstacle, so that obstacles more likely to harm the user are determined to have higher severity. For example, the sharp edge of a door or anther user may represent higher priority obstacles than the cushioned wall of a VR game facility. Characteristics of the obstacle may be determined via the hardware sensors previously described as being used to identify real-world obstacles. One example of rendering the context-associated VR object based on the severity includes the implementation of a feature in which determining a potential collision with higher severity results in rendering a context-associated VR objects to the user more immediately. Other examples include modulating features of the VR object such as size, brightness, and/or the speed of an animation based on severity. In some embodiments, VR objects are selected based on severity from a database in which the VR objects are categorized by severity. In some embodiments, the VR objects are provided to a remote database as an accessible service to other VR applications.

In some embodiments, the process 1500 also includes steps to track how the user responds to the generated context-appropriate VR object. These steps may include tracking information about the user's response such as the user's reaction time and/or their changes in position, velocity, and/or acceleration in response to the generated VR object. This information may be utilized for determining the way subsequent context-appropriate VR objects are displayed or how an in-use deterrent is modulated in intensity in real time to avoid a collision. For instance, if a user came dangerously close to an obstacle in a previous encounter, the timing and position of subsequent VR objects can be adjusted in order to more quickly guide the user away from subsequent potential collisions. This process may include adjustments to the determination of the severity of potential collisions. The collected information regarding a users response may be sent to a learning engine that is configured to determine modifications to the timing and generation of subsequent VR objects. In some embodiments, the learning engine receives information from the user of the VR headset during a VR session. In other embodiments, the learning engine may receive data collected over the course of many VR sessions and/or across many users. In some embodiments, collected user response data may be used as ongoing training patterns for deep learning AI systems (e.g., Google TensorFlow) that may be used for hazard detection. In some embodiments, the VR wearable display receives information from a learning engine that incorporates information collected from many VR headsets. In some embodiments, the learning engine is artificial intelligence (AI) based, e.g., uses Google DeepMind deep learning techniques and the like. In some embodiments, the learning engine executes machine learning processes on a special purpose processor, e.g., a graphics processing unit such as the Nvidia Titan X with virtual reality and deep learning support,

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more graphics processing units or AI deep learning cores, or one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, GPUs, vector processing units (VPUs), 2D/3D video processing units, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. A combination of the two approaches could be used.

Accordingly, some embodiments of the present disclosure, or portions thereof, may combine one or more processing devices with one or more software components (e.g., program code, firmware, resident software, micro-code, etc.) stored in a tangible computer-readable memory device, which in combination from a specifically configured apparatus that performs the functions as described herein. These combinations that form specially programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, and the like. A given module may even be implemented such that separate processor devices and/or computing hardware platforms perform the described functions.

Moreover, an embodiment can be implemented as a non-transitory computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be understood that various features are grouped together in various embodiments with the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method comprising:
generating a virtual reality (VR) scene using a VR wearable display device in a real-world VR viewing location;
identifying a real-world event in the real-world VR viewing location;
determining a context of the VR scene; and
applying a modification to the VR scene in response to the identified real-world event, wherein the modification is associated with the context of the VR scene.

2. The method of claim 1, wherein determining the context of the VR scene comprises receiving the context from a current VR program and wherein applying the modification to the VR scene in response to the identified real-world event comprises selecting a context-associated VR object from a database of VR objects.

3. The method of claim 1, wherein identifying the real-world event comprises using at least one selected from the group consisting of sonar, lidar, radar, stereo vision, motion tracking, artificial intelligence, and object recognition.

4. The method of claim 1, wherein identifying the real-world event comprises identifying an incoming digital communication.

5. The method of claim 4, wherein applying the modification to the VR scene in response to the identified real-world event comprises generating a context-associated object representing a characteristic of the incoming digital communication.

6. The method of claim 1, wherein identifying the real-world event comprises identifying a biometric parameter, wherein the biometric parameter is indicative of a physiological state of a VR user of the VR wearable display device and of the physiological state surpassing a threshold level for the physiological state.

7. The method of claim 6, wherein applying the modification to the VR scene in response to the identified real-world event comprises modulating the intensity of a current VR program.

8. The method of claim 1, wherein identifying the real-world event in the real-world VR viewing location comprises detecting a potential collision between a VR user of the VR wearable display device and an obstacle within the real-world VR viewing location.

9. The method of claim 8, further comprising:
determining a relative motion of the VR user with respect to the obstacle,
and wherein applying the modification to the VR scene in response to the identified real-world event comprises generating a context-associated VR object to affect the relative motion of the VR user with respect to the obstacle to avoid the potential collision.

10. The method of claim 9, further comprising:
determining information regarding a user response of the VR user to the context-associated VR object; and
sending the information regarding the user response to a learning engine, wherein the learning engine is configured to modify a timing for generating a subsequent context-associated VR object based at least in part on the information regarding the user response.

11. The method of claim 9, wherein generating the context-associated VR object comprises generating the context-associated VR object based at least in part on a potential severity of the potential collision.

12. The method of claim 11, wherein the potential severity is based on a relative velocity between the VR user and the obstacle and a distance between the VR user and the obstacle.

13. The method of claim 9, wherein the obstacle is a mobile object.

14. The method of claim 9, wherein the obstacle is a second VR user of a second VR wearable display device.

15. The method of claim 14, further comprising:
accessing a rule from a set of common rules, wherein the set of common rules is shared between the VR wearable display device and the second VR wearable device such that the VR wearable display device is configured to operate in accordance with the set of common rules;
providing guidance to the VR user with respect to avoiding potential collisions in accordance with the rule.

16. The method of claim 14, wherein generating the context-associated VR object comprises:
communicating with the second VR wearable display device to exchange cooperation information; and
generating the context-associated VR object based at least in part on the cooperation information.

17. The method of claim 16, wherein the cooperation information comprises anticipated changes in a direction and a location of at least one of the VR user or the second VR user.

18. A system comprising:
a processor; and
a non-transitory memory, the non-transitory memory storing instructions that, when executed by the processor, cause the processor to:
generate a virtual reality (VR) scene using a VR wearable display device in a real-world VR viewing location;
identify a real-world event in the real-world VR viewing location;
determine a context of the VR scene; and
apply a modification to the VR scene in response to the identified real-world event, wherein the modification is associated with the context of the VR scene.

19. The system of claim 18, wherein the system comprises the VR wearable display device, and wherein the VR wearable display device comprises the processor and the non-transitory memory.

20. A method comprising:
rendering initial virtual reality (VR) views to a VR user using a VR wearable display device in a real-world VR viewing location;
detecting a mobile real-world obstacle in the real-world VR viewing location;
detecting a potential collision between the VR user on a current trajectory and the mobile real-world obstacle on a second trajectory, the current trajectory intersecting with the second trajectory;
in response to detecting the potential collision, rendering, at a display of the VR wearable display device, a context-associated VR object in a VR view, wherein the context-associated VR object is configured to divert the VR user from the current trajectory of the VR user and to avoid the potential collision.

21-39. (canceled)
